(19) United States
(12) Patent Application Publication
(10) Pub. No.: US 2013/0321778 A1
(43) Pub. Date: Dec. 5, 2013

(54) IMAGE PROJECTION APPARATUS

(71) Applicant: Hideo KANAI, Tokyo (JP)

(72) Inventor: Hideo KANAI, Tokyo (JP)

(21) Appl. No.: 13/889,503

(22) Filed: May 8, 2013

(30) Foreign Application Priority Data
Jun. 4, 2012 (JP) 2012-127108

(51) Int. Cl. G03B 21/16

(52) U.S. Cl. CPC G03B 21/16
USPC 353/52

(57) ABSTRACT

An image projection apparatus includes a light source unit, an image generation unit, a projection optical unit, and an openably closable cover. The light source unit is detachably attached to the image projection apparatus. The image generation unit generates an image. The projection optical unit projects the image. The openably closable cover opens or closes an opening disposed for attachment and detachment of the light source unit. The openably closable cover includes a moveable operation device attached to the cover and a regulating device. The operation device is selectively operated for a first mode, in which the openably closable cover is locked to the image projection apparatus, and a second mode, in which the openably closable cover is unlocked from the image projection apparatus. The regulating device regulates movement of the operation device when the temperature of the light source unit becomes a given level.

### CROSS-REFERENCE TO RELATED APPLICATION

This application claims priority pursuant to 35 U.S.C. §119 to Japanese Patent Application No. 2012-127108, filed on Jun. 4, 2012 in the Japan Patent Office, the disclosure of which is incorporated by reference herein in its entirety.

### TECHNICAL FIELD

The present invention relates to an image projection apparatus.

### BACKGROUND ART

Image projection apparatuses such as projectors receive image data from personal computers or video cameras to project an image. The image projection apparatus projects and displays the image onto a screen using light emitted from a light source. The light source of the image projection apparatus is, for example, a halogen lamp, a metal-halide lamp, or a high-pressure mercury vapor lamp, all of which generate heat when they emit light.

JP-2002-139797-A discloses an image projection apparatus in which a user replaces a light source with a new one when the light source ends its lifetime. In particular, FIG. 38 shows a schematic configuration of the light source of conventional image projection apparatuses. As shown in FIG. 38, a light source unit 206 including a light source 261 and a light source holder 245 holding the light source 261 is installed in a light source attachment unit 204 disposed inside a casing 202. The bottom of the casing 202 has an opening 253 formed therein below the light source unit 206, which is used when replacing the light source unit 206. The opening 253 is covered by an openably closable cover 230.

A claw 230a protrudes from one end of the cover 230 (left side in FIG. 38) cover 230. The claw 230a engages a concavity 238a disposed at an inner side of a bottom face 202b of the casing 202. Further, the cover 230 has a coupling opening 230c formed therein and a coupling member 230b disposed inside the coupling opening 230c while protruding in the casing 202. The coupling member 230b has a through-hole 230b1 formed therein. The coupling member 230b contacts a support member 241 in the projector. The support member 241 has a threaded hole 241a formed therein that is threaded with a screw 240. The screw 240 is inserted in the through-hole 230b1. Through the coupling opening 230c, a tool such as a screwdriver is fitted to the screw 240 to screw the screw 240. Then, the coupling member 230b is coupled to the support member 241, and the cover 230 is fixed to the casing 202.

FIG. 39 shows a cross-sectional view of the light source unit 206 when the cover 230 is opened. When replacing the light source 261, a tool is fitted to the screw 240 through the coupling opening 230c to unscrew the screw 240 so that the coupling member 230b is released from the support member 241 and the cover 230 can be removed from the casing 202. When the cover 230 is removed from the casing 202, the light source unit 206 is exposed through the opening 253, and then the light source unit 206 can be removed from the casing 202 through the opening 253 and a new light source unit 206 can be installed in the light source attachment unit 204 when cover 23 is opened.

Further, as shown in FIG. 38, JP-2002-139797-A discloses a mechanism that prevents the cover 230 from accidentally opening when the light source 206 heats up, wherein the mechanism is constructed of a shield plate 231 to cover the coupling opening 230c and a heat-sensitive operating member 232 connected to the shield plate 231. The shield plate 231 fixed at one end of the heat-sensitive operating member 232 can be dimensioned to cover the coupling opening 230c. The other end of the heat-sensitive operating member 232 is fixed to the cover 230.

At room temperature, as shown in FIG. 40, the heat-sensitive operating member 232 is not deformed by the heat from the light source 206, and the coupling opening 230c is not blocked by the shield plate 231. Accordingly, the screw 240 can be accessed with ease. In contrast, when the light source holder 245 is at a high temperature, the heat-sensitive operating member 232 does deform, and then the shield plate 231 moves to a position blocking the coupling opening 230c as shown in FIG. 41. In this state, access to the screw 240 is deliberately hindered, thereby preventing access while the light source 230 is still hot.

However, in the above described image projection apparatus, the cover 230 is fixed to the casing 202 with the screw 240. Therefore, when removing the cover 230 from the casing 202, a tool such as a screwdriver is required, thus complicating replacement.

### SUMMARY

In one aspect of the present invention, an image projection apparatus includes a light source unit, an image generation unit, a projection optical unit, and an openably closable cover. The light source unit includes a detachable light source attached to a body of the image projection apparatus. The image generation unit generates an image using light emitted from the light source. The projection optical unit projects the image. The cover opens or closes an opening disposed for attachment and detachment of the light source unit with respect to the body of the image projection apparatus. The cover includes a moveable operation device attached to the cover and a regulating device. The operation device is selectively operated for a first mode, in which the cover is locked to the body of the image projection apparatus, and a second mode, in which the cover is unlocked from the body of the image projection apparatus. The regulating device regulates movement of the operation device when the temperature of the light source unit becomes a given level or more.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 shows a perspective view of a projector according to an example embodiment and a projection plane;

FIG. 2 shows a pattern of light paths from a projector to a projection plane;

FIG. 3 shows a schematic perspective view of a projector;

FIG. 4 shows a perspective view of a main unit of a projector;

FIG. 5 shows a perspective view of an image generation unit;

FIG. 6 shows a schematic perspective view of a light source unit;

FIG. 7 shows a perspective view of an image generation unit and a lighting unit;

FIG. 8 shows a perspective view of the image generation unit of FIG. 7;

FIG. 9 shows a perspective view of a first optical unit with the lighting unit and the image generation unit;

FIG. 10 shows a cross-sectional view along a line D-D of FIG. 9;

FIG. 11 shows a perspective view of a second optical unit configured with a projection lens unit, the lighting unit, and the image generation unit;

FIG. 12 shows a perspective view of the second optical unit configured with the first optical unit, the lighting unit, and the image generation unit;

FIG. 13 shows a schematic view of the light path from the first optical system to a projection plane;

FIG. 14 schematically shows a layout of units in the projector;

FIG. 15 shows an example of use environment of the projector according to an example embodiment;

FIG. 16 shows an example of use environment of a conventional projector;

FIG. 17 shows another example of use environment of a conventional projector;

FIG. 18 shows an example of another use environment of the projector according to an example embodiment;

FIG. 19 shows a perspective view of the projector viewed from a bottom face of the projector;

FIG. 20 shows a perspective view of the projector when an openably closable cover is removed from the projector;

FIG. 21 shows a schematic view of airflow patterns in the projector;

FIG. 22 shows a perspective view of a cooling unit to cool a digital mirror device, a lighting unit, and a light source unit;

FIG. 23 shows a cross-sectional view of FIG. 22;

FIG. 24 shows a perspective view of a horizontal duct, a light source unit, and a base member;

FIG. 25 shows air routes from a horizontal duct to a light source bracket viewed from a lower side;

FIG. 26 shows air routes from a horizontal duct to a light source bracket viewed from an upper side;

FIG. 27 shows a perspective view of an openably closable cover;

FIG. 28 shows a perspective view of a rotate-able member;

FIGS. 29(a) and 29(b) show perspective views of a rotate-able member and an openably closable cover when attaching the rotate-able member;

FIG. 30 shows a perspective view of a base member when the openably closable cover is attached to a light source replacement opening of the base member;

FIG. 31 shows a perspective view of a base member when the openably closable cover is locked to the light source replacement opening of the base member;

FIGS. 32A, 32B and 32C show a process of locking the openably closable cover to the light source replacement opening of the base member;

FIG. 33 shows a perspective view of the lighting unit and the light source unit attached on the base member;

FIG. 34 shows a perspective view of the light source unit and the rotate-able member when the rotate-able member is at an unlock position viewed from a direction of an arrow F of FIG. 33;

FIG. 35 shows a perspective view of the light source unit and the rotate-able member when the rotate-able member is at a lock position viewed from a direction of an arrow F of FIG. 33;

FIGS. 36A and 36B show a condition that a rotational sliding movement of the rotate-able member is regulated by a regulating mechanism;

FIGS. 37A and 37B show a condition that a rotational sliding movement of the rotate-able member is not regulated by a regulating mechanism;

FIG. 38 shows a schematic configuration around a light source of conventional image projection apparatuses;

FIG. 39 shows a cross-sectional view of the image projection apparatus of FIG. 38 when an openably closable cover is opened;

FIG. 40 shows an openably closable cover of the image projection apparatus of FIG. 38 not regulating an opening; and

FIG. 41 shows an openably closable cover of the image projection apparatus of FIG. 38 regulating an opening.

The accompanying drawings are intended to depict exemplary embodiments of the present invention and should not be interpreted to limit the scope thereof. The accompanying drawings are not to be considered as drawn to scale unless explicitly noted, and identical or similar reference numerals designate identical or similar components throughout the several views.

### DETAILED DESCRIPTION OF EXEMPLARY EMBODIMENTS

A description is now given of exemplary embodiments of the present invention. It should be noted that although such terms as first, second, etc. may be used herein to describe various elements, components, regions, layers and/or sections, it should be understood that such elements, components, regions, layers and/or sections are not limited thereby because such terms are relative, that is, used only to distinguish one element, component, region, layer or section from another region, layer or section. Thus, for example, a first element, component, region, layer or section discussed below could be termed a second element, component, region, layer or section without departing from the teachings of the present invention.

In addition, it should be noted that the terminology used herein is for the purpose of describing particular embodiments only and is not intended to be limiting of the present invention. Thus, for example, as used herein, the singular forms “a”, “an” and “the” are intended to include the plural forms as well, unless the context clearly indicates otherwise. Moreover, the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Furthermore, although in describing views shown in the drawings, specific terminology is employed for the sake of clarity, the present disclosure is not limited to the specific terminology so selected and it is to be understood that each specific element includes all technical equivalents that have the same function, operate in a similar manner, and achieve a similar result. Referring now to the drawings, an apparatus or system for an image projection apparatus such as a projector according to an example embodiment is described hereinafter.

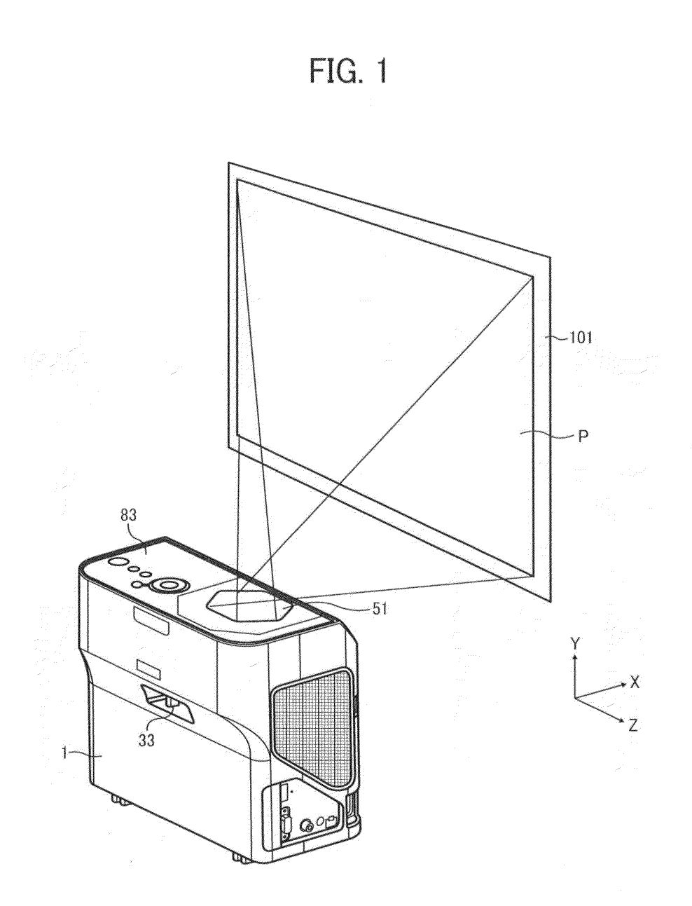

FIG. 1 shows a perspective view of a projector 1 and a projection plane 101. The projector 1 includes, for example, a transparent glass 51, an operation unit 83, and a focus lever 33. As shown in FIG. 1, the projector 1 has the transparent glass 51 on its top face, from which a projected image P is projected to the projection plane 101. The projected image P projected from the transparent glass 51 is displayed on the projection plane 101 such as a screen. Further, the projector 1 has the operation unit 83 on its top face, by which a user can operate the projector 1. Further, the projector 1 has the focus lever 33 on its side face for adjusting the focus of image. Hereinafter, the normal line direction of the projection plane 101 is set as X direction, the short side direction of the projection plane 101 (or top/bottom direction) is set as Y direction, and the long side direction of the projection plane 101 (or horizontal direction) is set as Z direction.

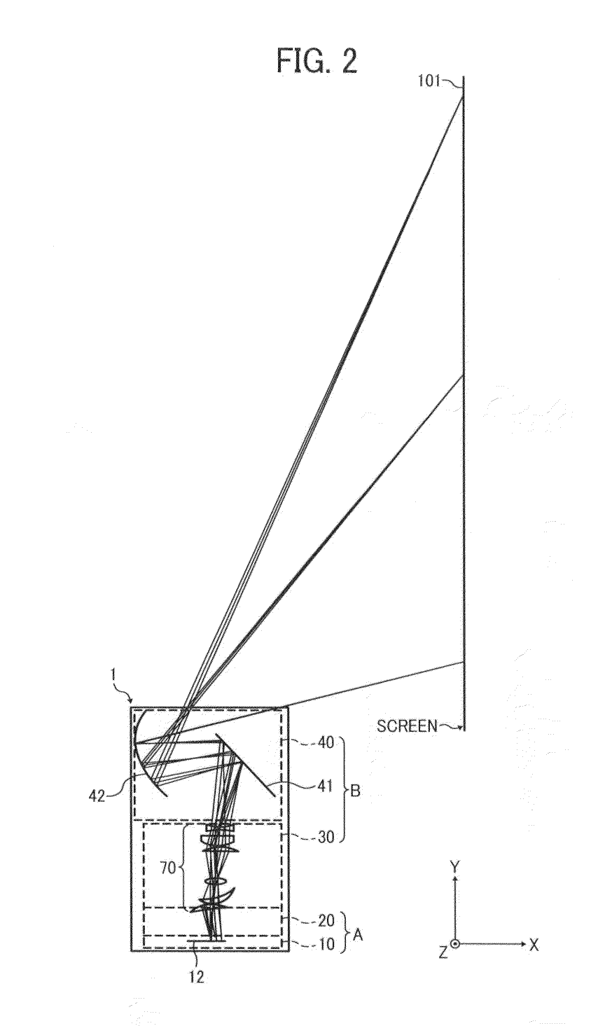

FIG. 2 shows a pattern of light paths from the projector 1 to the projection plane 101. The projector 1 includes, for example, a light source unit having a light source, and an image generator A to generate images using the light emitted from the light source. The image generator A includes, for example, an image generation unit 10, and a lighting unit 20. The projector 1 further includes a projection optical system B used as a projection optical apparatus.

The image generation unit 10 includes an image generation element such as a digital mirror device (DMD) 12. The lighting unit 20 reflects and radiates light coming from the light source to the DMD 12 to generate a light image. The projection optical system B projects the light image on the projection plane 101. The projection optical system B includes a least one pass-through type reflection optical system. For example, the projection optical system B includes a first optical unit 30, and a second optical unit 40. The first optical unit 30 includes, for example, a first optical system 70 of co-axial system having a positive power. The second optical unit 40 includes, for example, a reflection mirror 41, and a curved mirror 42 having a positive power.

The DMD 12 can generate an image using the light emitted from the light source. Specifically, the light emitted from the light source radiates the DMD 12 and an image is generated by modulating the light radiated by the lighting unit 20. The image generated by the DMD 12 is projected onto the projection plane 101 via the first optical system 70 of the first optical unit 30, and the reflection mirror 41 and the curved mirror 42 of the second optical unit 40.

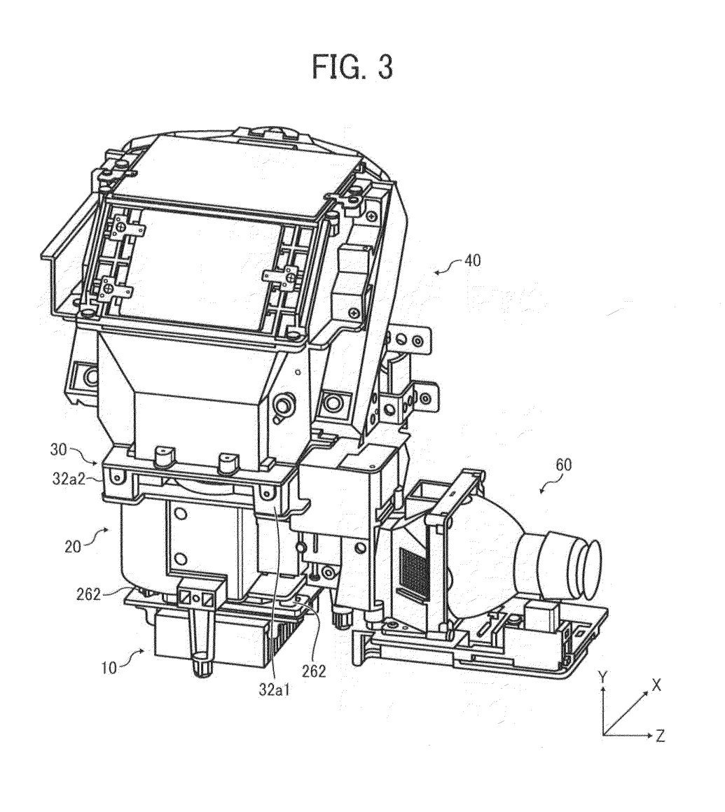

FIG. 3 shows a schematic perspective view of an internal configuration of the projector 1. As shown in FIG. 3, the image generation unit 10, the lighting unit 20, the first optical unit 30, the second optical unit 40 can be arranged along the Y direction in FIG. 3 parallel to the projection plane 101. Further, a light source unit 60 can be disposed at a right side of the lighting unit 20 in FIG. 3.

Further, as shown in FIG. 3, the first optical unit 30 has a lens holder 32 having legs 32a1 and 32a2, and the image generation unit 10 has screw stoppers 262 used to fix the image generation unit 10 to the lighting unit 20 using a screw.

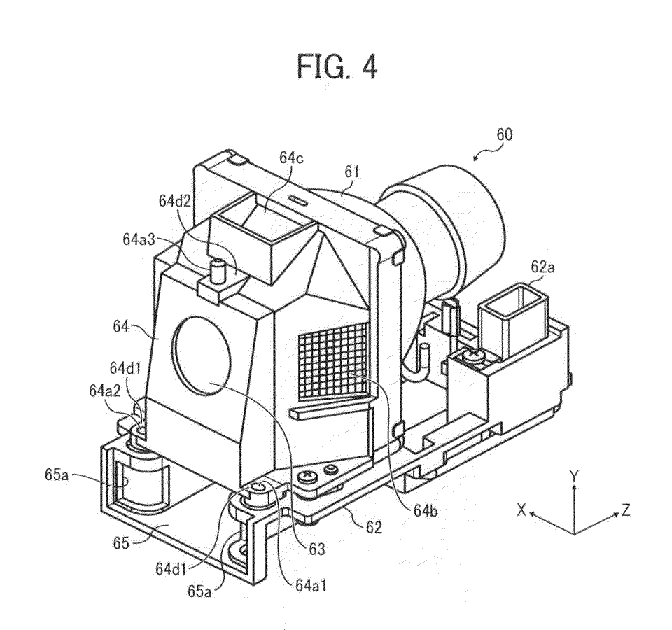

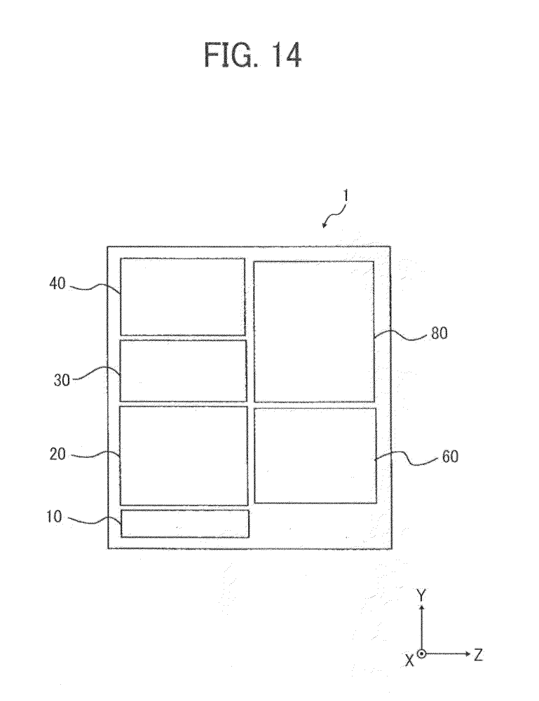

A description is given of the configuration of each unit. Initially, the light source unit 60 is described. FIG. 4 shows a schematic perspective view of the light source unit 60. The light source unit 60 includes a light-source bracket 62, and a light source 61 fixed on the light-source bracket 62. The light source 61 is, for example, a halogen lamp, a metal-halide lamp, and a high-pressure mercury vapor lamp. Further, the light-source bracket 62 has a connector 62a connectable to a power-source connector of a power source unit 80 (see FIG. 14).

Further, a holder 64 is fixed on the light exiting side of the light source 61 disposed on the light-source bracket 62 by using screws, wherein the holder 64 retains a reflector or the like. Further, a light exiting window 63 is disposed for the holder 64 while the light exiting window 63 is disposed at a side opposite the position of the light source 61. The light emitted from the light source 61 can be guided to the light exiting window 63 by the reflector retained in the holder 64, and exits from the light exiting window 63.

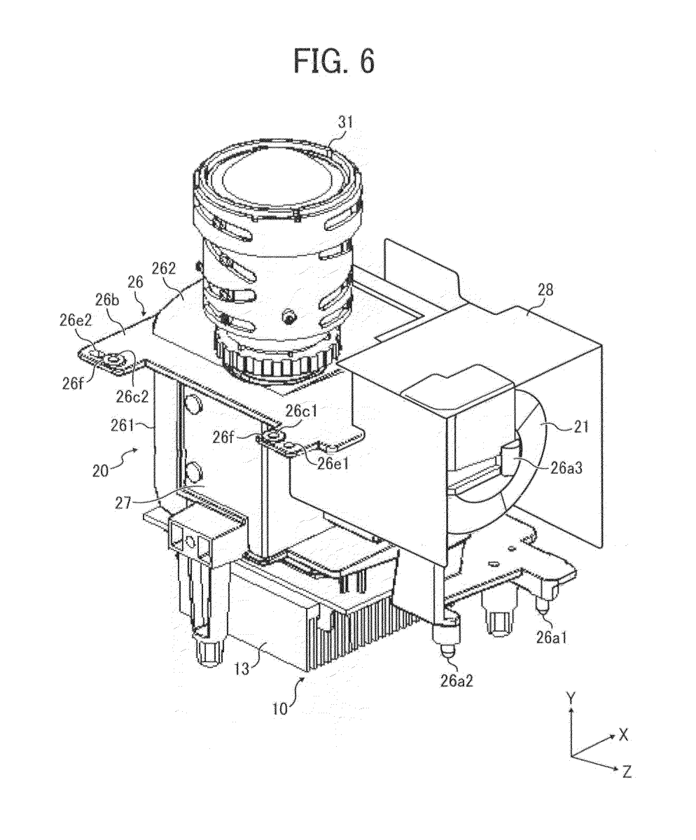

Further, light source position-setting members 64a1 to 64a3 are disposed at the top face of the holder 64 and both ends of the X direction of the bottom face of the holder 64 so that the light source unit 60 can be positioned correctly on a lighting unit bracket 26 of the lighting unit 20 (FIG. 6). For example, the light source position-setting member 64a3 disposed at the top face of the holder 64 has a protruded-shape, and the light source position-setting members 64a1 and 64a2 disposed at the bottom face of the holder 64 have a hole shape.

Further, a light-source air intake port 64b is disposed at a side face of the holder 64 to take in air used for cooling the light source 61, and a light-source air exhaust port 64c is disposed at the top face of the holder 64 to exhaust air heated by the heat of the light source 61.

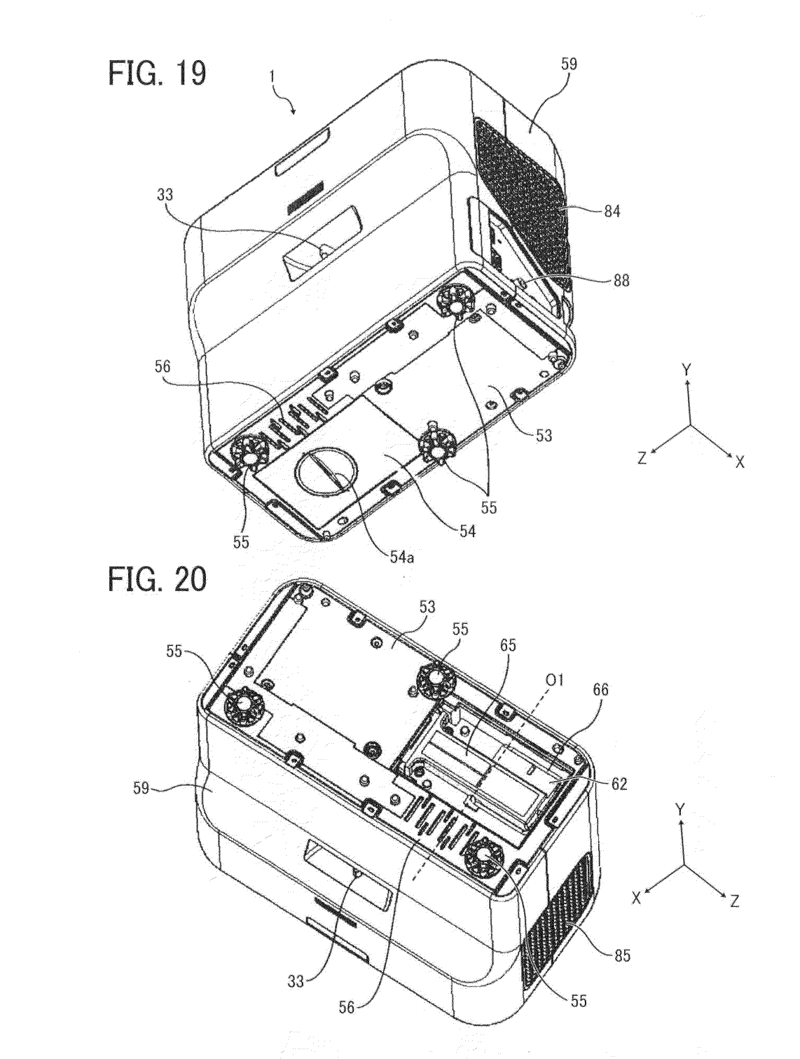

Further, a pass-through area 65 is disposed for the light-source bracket 62 to take in air sucked in by an air-intake blower 91 (see FIG. 20) to be described later. Further, an opening 65a is disposed at an air-intake side of the pass-through area 65 as shown in FIG. 4 to send a part of airflow flowing into the pass-through area 65 to a space between the light source unit 60 and an openably closable cover 54 (FIG. 19), to be described later. Hereinafter, the openably closable cover 54 may be referred to the cover 54 for the simplicity of expression. The cooling of the light source unit 60 will be described later. The pass-through area 65 may be also referred to as the duct 65.

Further, as shown in FIG. 4, the light source position-setting member 64a3 having a protruded-shape is provided on a plane face portion 64d2 disposed at the top face of the holder 64, and the light source position-setting members 64a1 and 64a2 having the hole shape is disposed at a plane face portion 64d1 of the bottom face of the holder 64. The plane face portion 64d2 and the plane face portion 64d1 can be used as contact members to be contacted to the lighting unit bracket 26 when pushed or pressed by a push member, to be described later, provided for the cover 54.

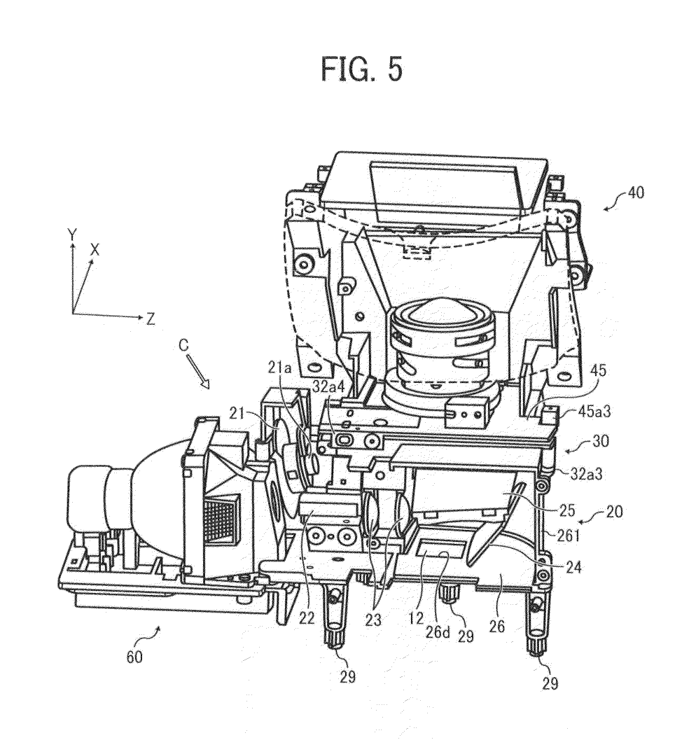

A description is given of the lighting unit 20 with reference to FIG. 5, which shows a perspective view of optical parts encased in the lighting unit 20, and other units. As shown in FIG. 5, the lighting unit 20 includes, for example, a color wheel 21, a light tunnel 22, two relay lenses 23, a cylinder mirror 24, a concave mirror 25, wherein the parts can be retained by the lighting unit bracket 26. The lighting unit bracket 26 includes, for example, a casing 261 that encases the relay lenses 23, the cylinder mirror 24, and the concave mirror 25. Among four sides of the casing 261, only one side has a side face (i.e., right side of FIG. 5), and other three sides are opening. Further, an OFF plate 27 (FIG. 6) is disposed at one opening-side of the X direction in FIG. 5, and a cover member is disposed at another opening-side of the X direction in FIG. 5. With this configuration, the relay lenses 23, the cylinder mirror 24, and the concave mirror 25 encased in the casing 261 of the lighting unit bracket 26 can be covered by the lighting unit bracket 26, the OFF plate 27, and the cover member.

Further, a through-hole 26d is disposed on the bottom face of the casing 261 of the lighting unit bracket 26 so that the DMD 12 can be exposed through the through-hole 26d.

Further, the lighting unit bracket 26 includes, for example, three legs 29. The legs 29 can contact a base member 53 (FIG. 19) of the projector 1 to support the weight of the first optical unit 30 and the second optical unit 40 stacked and fixed on the lighting unit bracket 26. Further, by providing the legs 29, a space for taking in external air to a heat exchanger such as a heat sink 13 (FIG. 6) that cools the DMD 12 of the image generation unit 10, can be arranged, to be described later.

Further, as shown in FIG. 5, the lens holder 32 of the first optical unit 30 includes, for example, legs 32a3 and 32a4, and the second optical unit 40 includes, for example, a screw stopper 45a3.

FIG. 6 shows a perspective view of the image generation unit 10, the lighting unit 20, and a projection lens unit 31 viewed from the direction C shown in FIG. 5. The casing 261 of the lighting unit bracket 26 has a top face 26b extending in a direction perpendicular to the Y direction of FIG. 6. Through-holes are disposed at four corners of the top face 26b to fasten the first optical unit 30 with screws by inserting the screws into the through-holes. For example, FIG. 6 shows the through-holes 26c1 and 26c2.

Further, as shown in FIG. 6, position-setting holes 26e1 and 26e2 are respectively disposed next to the through-holes 26c1 and 26c2 to set the first optical unit 30 at a correct position with the lighting unit 20. As for the position-setting holes 26e1 and 26e2, the position-setting hole 26e1 disposed at the color wheel 21 side is used as a primary position-setting hole having a circular hole shape, and the position-setting hole 26e2 disposed at an opposite side of the color wheel 21 is used as a secondary position-setting hole having a slot hole extending in the Z direction.

Further, a position-setting protrusion 26f is disposed around each of the through-holes 26c1 and 26c2, wherein the position-setting protrusion 26f protrudes from the top face 26b of the lighting unit bracket 26. The position-setting protrusion 26f is used to set the first optical unit 30 at a correct position in the Y direction. If the precision of positioning is to be enhanced in the Y direction without providing the position-setting protrusion 26f, the flatness of the entire top face of the lighting unit bracket 26 is required to be enhanced, which is costly. By providing the position-setting protrusion 26f, the flatness is required to be enhanced only at the position-setting protrusion 26f. Therefore, the precision of positioning can be enhanced in the Y direction while reducing the cost.

Further, the top face of the lighting unit bracket 26 has an opening covered by a light shield plate 262 engaging with the lower end of the projection lens unit 31, by which the intrusion of light from the upper side into the casing 261 can be prevented.

Further, the top face 26b of the lighting unit bracket 26 has a cutout between the through-holes 26c1 and 26c2 of the top face 26b so that the second optical unit 40 can be screwed to the first optical unit 30 easily, to be described later.

A light source positioning member 26a3 is disposed at one end of the lighting unit bracket 26 at the color wheel 21 side (Z direction in FIG. 6). The light source positioning member 26a3 has a cylinder-like shape having a through-hole, to which the light source position-setting member 64a3 having the protruded-shape (FIG. 4), disposed at the top face of the holder 64 of the light source unit 60, can engage. Further, two light source positioning members 26a1 and 26a2 having protruded-shape are disposed at a lower side of the light source positioning member 26a3, to which the light source position-setting member 64a1 and 64a2 disposed on the holder 64 at the light-source bracket 62 side, which are the through-holes, can engage respectively. By respectively engaging the light source position-setting members 64a1 to 64a3 disposed for the holder 64 to the light source positioning members 26a1 to 26a3 disposed for the lighting unit bracket 26 of the lighting unit 20, the light source unit 60 can be fixed at the correct position with respect to the lighting unit 20 (FIG. 3).

Further, the lighting unit bracket 26 includes a lighting unit cover 28 that covers the color wheel 21 and the light tunnel 22.

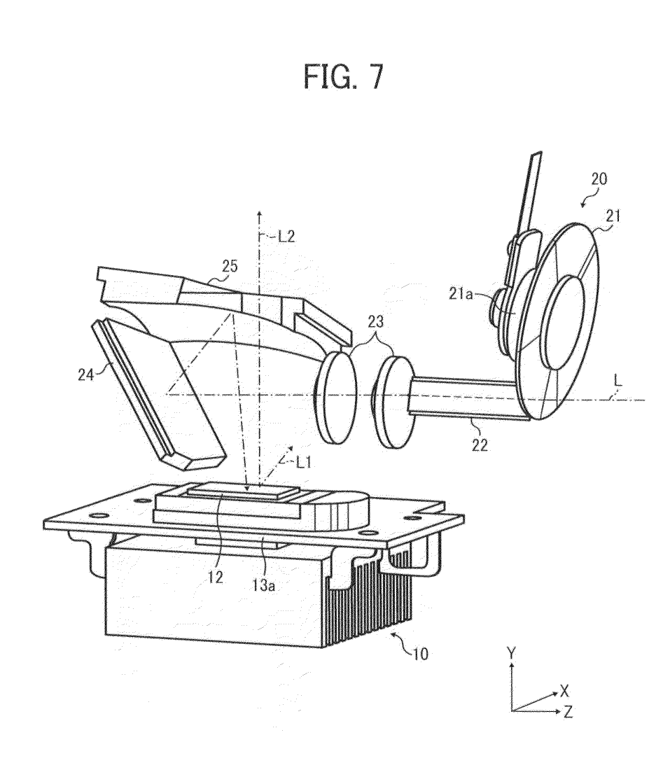

FIG. 7 shows a light path L of light in the lighting unit 20. The color wheel 21 has a disc shape and is fixed on a motor shaft of a color motor 21a. The color wheel 21 includes, for example, R (red), G (green), and B (blue) filters along the rotation direction of the color wheel 21. The light focused by a reflector disposed for the holder 64 of the light source unit 60 passes through the light exiting window 63, and then reaches the peripheral area of the color wheel 21. The light that has reached the peripheral area of the color wheel 21 is separated into R, G and B lights along the timeline as the color wheel 21 rotates.

The light separated by the color wheel 21 enters the light tunnel 22. The light tunnel 22 is a tube-shaped member having a square-like cross shape, and its internal face is finished as a mirror face. The light entered the light tunnel 22 reflects a plurality of times on the internal face of the light tunnel 22, and is then emitted as uniform light to the relay lenses 23.

The light that has passed the light tunnel 22 passes the two relay lenses 23, reflects on the cylinder mirror 24 and the concave mirror 25, and is then focused on an image generation face of the DMD 12 as an image.

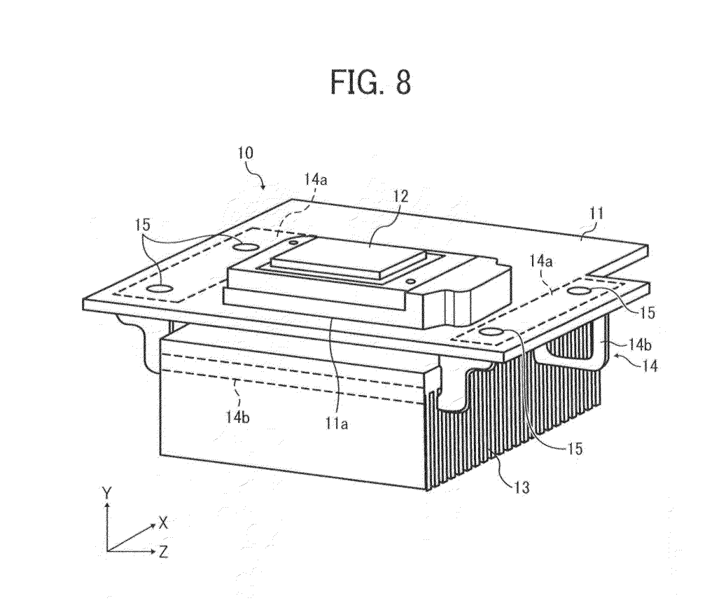

A description is given of the image generation unit 10 with reference to FIG. 8, which shows a perspective view of the image generation unit 10. As shown in FIG. 8, the image generation unit 10 includes, for example, a DMD board 11 to which the DMD 12 is attached. The DMD 12 is attached to a socket 11a disposed on the DMD board 11 while orienting an image generation face of the DMD 12 composed of micro mirrors arranged in a lattice pattern to an upward direction. The DMD board 11 includes a drive circuit to drive the micro mirrors.

A heat exchanger such as the heat sink 13 is fixed on a distal side of the DMD board 11 (i.e., a face opposite a face having the socket 11a) to cool the DMD 12. The DMD board 11 has a through-hole area to which the DMD 12 is attached, and the heat sink 13 has a protruded portion 13a (FIG. 7) insertable into the through-hole area. The protruded portion 13a has an edge portion having a flat shape. By inserting the protruded portion 13a into the through-hole area, the flat edge portion of the protruded portion 13a can contact the distal side of the DMD 12 (i.e., face opposite the image generation face). An elastic and flexible heat conduction sheet can be attached on the flat edge portion of the protruded portion 13a and/or an area of the distal side of the DMD 12 so that the heat sink 13 and the distal side of the DMD 12 can be closely contacted to enhance thermal conductivity.

The heat sink 13 can be fixed on a face opposite a face disposed of the socket 11a of the DMD board 11 by applying pressure using a fixing device 14. The fixing device 14 includes, for example, a plate-like fixing part 14a at a right distal side of the DMD board 11 (right side in FIG. 8), and a plate-like fixing part 14a at a left distal side of the DMD board 11 (left side in FIG. 8) disposed at as counterpart members with each other. As shown in FIG. 8, one end and other end of the plate-like fixing parts 14a are linked by a pressure member 14b extending in the Z direction in FIG. 8.

When the image generation unit 10 is fixed to the lighting unit bracket 26 (FIG. 6) using screws, the heat sink 13 is pressed and fixed to the face opposite the face disposed of the socket 11a of the DMD board 11 by applying force from the fixing device 14.

A description is given of fixing of the lighting unit bracket 26 of the image generation unit 10. Initially, the image generation unit 10 is positioned with respect to the lighting unit bracket 26 so that the DMD 12 can face the through-hole 26d disposed on the bottom face of the lighting unit bracket 26 of the lighting unit 20 (FIG. 5). Then, a screw is inserted into each of through-holes disposed for the fixing part 14a, and each of through-holes 15 disposed for the DMD board 11 from a lower side, and the screw is screwed into each of screw holes disposed at the bottom face of the screw stopper 262 (FIG. 3) of the lighting unit bracket 26 to fix the image generation unit 10 to the lighting unit bracket 26. Further, as the screw is screwed into the screw stopper 262 disposed for the lighting unit bracket 26, the pressure member 14b presses the heat sink 13 toward the DMD board 11. With this configuration, the heat sink 13 can be pressed and fixed on the face opposite the face disposed with the socket 11a of the DMD board 11 by using the fixing device 14.

As above described, the image generation unit 10 can be fixed to the lighting unit bracket 26, and the three legs 29 shown in FIG. 5 can support the weight of the image generation unit 10.

The image generation face of the DMD 12 is composed of a plurality of movable micro mirrors arranged in a lattice pattern. Each of micro mirrors can incline the minor face about a torsion shaft for a given angle, and can be set with two conditions of “ON” and “OFF”. When the micro mirror is set “ON”, the light coming from the light source 61 is reflected toward the first optical system 70 (FIG. 2) as shown by an arrow L2 shown in FIG. 7. When the micro mirror is set “OFF”, the light coming from the light source 61 is reflected toward the OFF plate 27, retained on the side face of the lighting unit bracket 26 shown in FIG. 6, as shown by an arrow L1 shown in FIG. 7. Therefore, by driving each mirror independently, the light projection can be controlled for each pixel of image data to generate an image.

The light reflected to the OFF plate 27 is absorbed as heat and then the OFF plate 27 is cooled by the airflow flowing outside of the OFF plate 27.

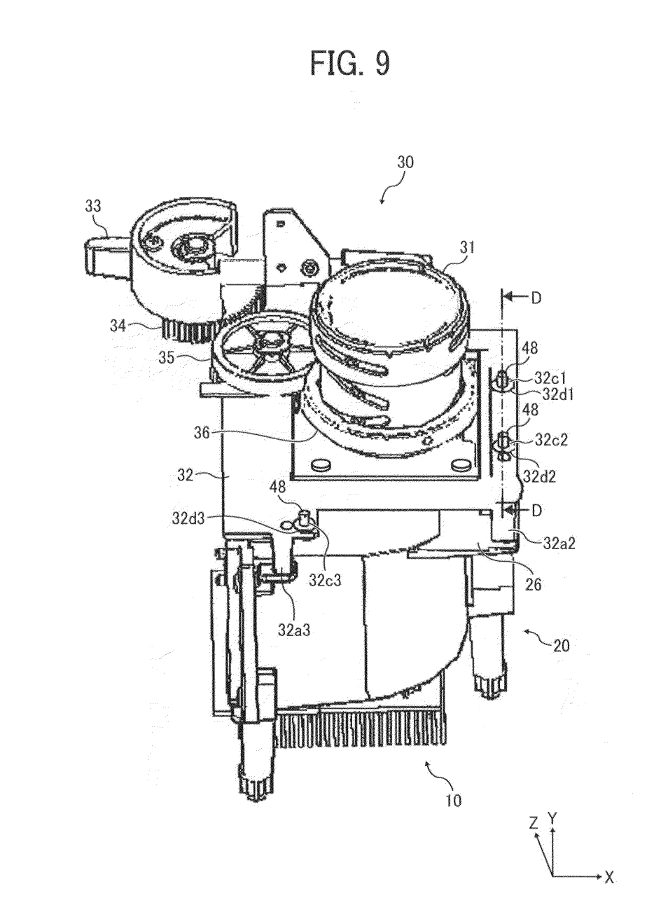

A description is given of the first optical unit 30 with reference to FIG. 9, which shows a perspective view of the first optical unit 30 with the lighting unit 20 and the image generation unit 10. As shown in FIG. 9, the first optical unit 30 is disposed over the lighting unit 20, and includes, for example, the projection lens unit 31, and the lens holder 32. The projection lens unit 31 retains the first optical system 70 (FIG. 2) composed of a plurality of lenses, and the lens holder 32 retains the projection lens unit 31. The lens holder 32 is disposed with four legs 32a1 to 32a4 extending toward the downside, wherein FIG. 9 shows the legs 32a2 and 32a3. The leg 32a1 is shown in FIG. 3, and the leg 32a4 is shown in FIG. 5. Each of the legs 32a1 to 32a4 is formed of a screw hole on its bottom face to be used when fixed with the lighting unit bracket 26 using a screw.

Further, the projection lens unit 31 is disposed with a focus gear 36 meshed with an idler gear 35. The idler gear 35 is meshed with a lever gear 34, and the focus lever 33 is fixed to a rotation shaft of the lever gear 34. As shown in FIG. 1, the end of the focus lever 33 is exposed outside of the projector 1.

When the focus lever 33 is operated, the focus gear 36 is rotated via the lever gear 34 and the idler gear 35. When the focus gear 36 is rotated, each of the plurality of lenses composing the first optical system 70 disposed in the projection lens unit 31 can be moved to a given direction to adjust a focal point of a projected image.

Further, the lens holder 32 includes, for example, threaded through-holes 32c1 to 32c3 so that the second optical unit 40 can be fixed with the first optical unit 30 using screws, in which a screw 48 is screwed into each of the threaded through-holes 32c1 to 32c3. FIG. 9 shows three threaded through-holes 32c1 to 32c3, and the screw 48 is inserted into each of the threaded through-holes 32c1 to 32c3. In FIG. 9, the end of the screw 48 is shown. Further, positioning protruded members 32d1 to 32d3 are respectively formed around each of the threaded through-holes 32c1 to 32c3, in which each of the positioning protruded members 32d1 to 32d3 protrudes from the face of the lens holder 32. FIG. 9 shows the positioning protruded members 32d1 to 32d3.

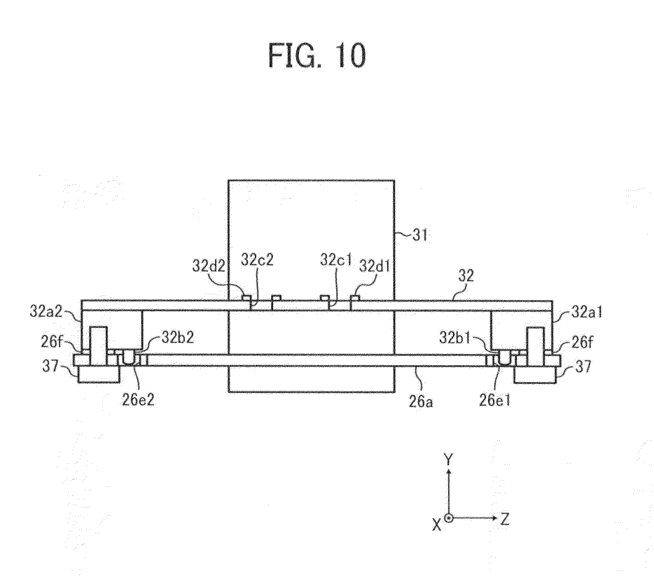

FIG. 10 shows a cross-sectional view along a line D-D of FIG. 9. As shown in FIG. 10, each of the legs 32a1 and 32a2 is disposed with positioning protruded members 32b1 and 32b2, respectively. The positioning protruded member 32b1 (right side in FIG. 10) is inserted in the position-setting hole 26e1 having the circular hole shape, which is the primary position-setting hole disposed on the top face 26b of the lighting unit bracket 26. The positioning protruded member 32b2 (left side in FIG. 10) is inserted in the position-setting hole 26e2 having the slot hole shape, which is the secondary position-setting hole. With this configuration, the position in the Z direction and X direction can be set correctly. Further, a screw 37 is inserted into each of the through-holes 26c1 to 26c4 disposed for the top face 26b of the lighting unit bracket 26, and then screwed into screw holes of each of the legs 32a1 to 32a4 of the lens holder 32, by which the first optical unit 30 can be fixed to the lighting unit 20 with a correct position.

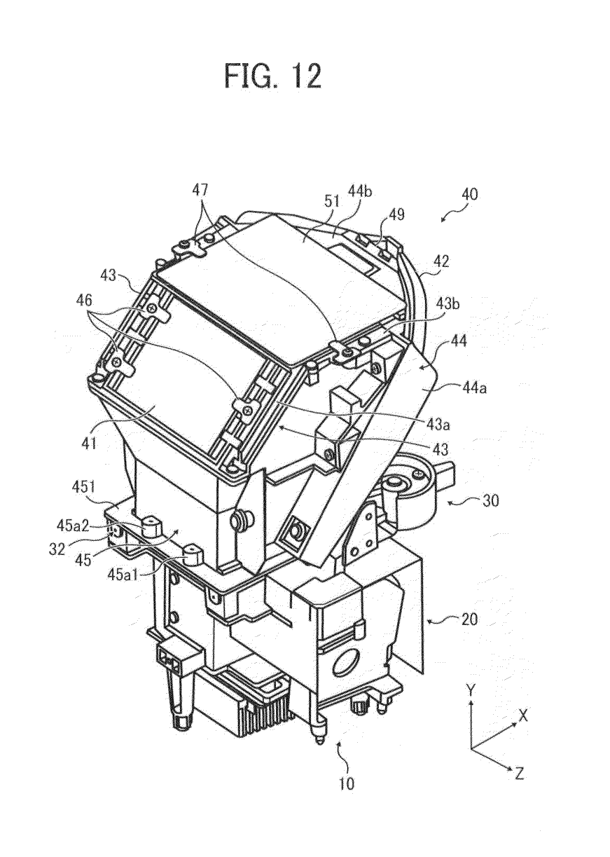

The second optical unit 40 includes a mirror holder 45 (see FIG. 12) that covers a portion of the projection lens unit 31 above the lens holder 32 to be described later. Further, as shown in FIG. 3, a space between a part of the lens holder 32, lower than a part of the lens holder 32 corresponding to the projection lens unit 31 and the top face 26b of the lighting unit bracket 26 of the lighting unit 20 is exposed outside. However, because the projection lens unit 31 engages the lens holder 32, the light does not enter the light path of projection light from such exposed part.

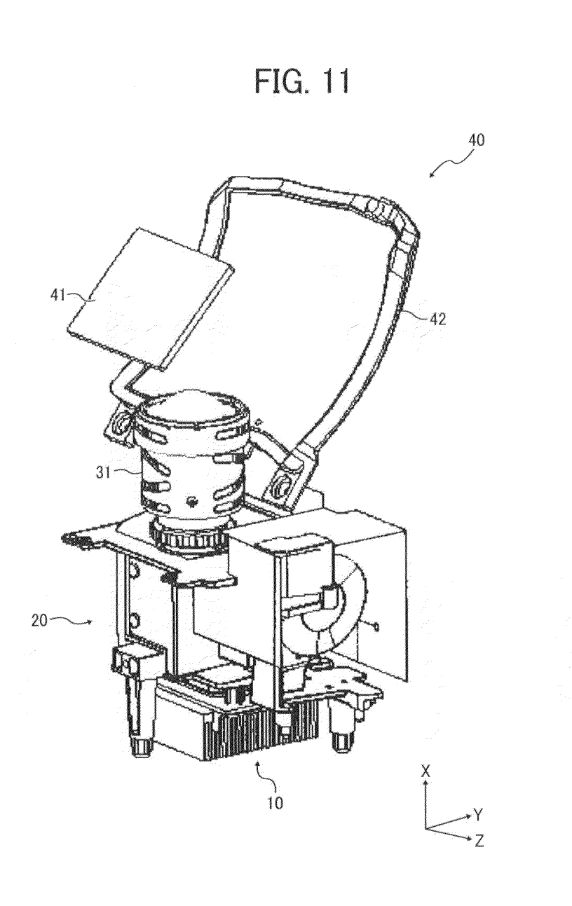

A description is given of the second optical unit 40 with reference to FIGS. 11 and 12. FIG. 11 shows a perspective view of the second optical unit 40 used as a second optical system configured with the projection lens unit 31, the lighting unit 20, and the image generation unit 10. As shown in FIG. 11, the second optical unit 40 includes, for example, the reflection mirror 41, and the curved mirror 42 having the concave shape. The reflection face of the curved mirror 42 can be finished as a circular face, a rotation symmetrical non-circular face, a free curve shape, or the like.

FIG. 12 shows a perspective view of the second optical unit 40 with the first optical unit 30, the lighting unit 20, and the image generation unit 10. The second optical unit 40 passes the light reflected from the curved mirror 42, and includes the transparent glass 51 to prevent intrusion of dust to optical parts in the projector 1.

The second optical unit 40 includes, for example, a mirror bracket 43, a free mirror bracket 44, and a mirror holder 45. The mirror bracket 43 retains the reflection mirror 41 and the transparent glass 51. The free mirror bracket 44 retains the curved mirror 42. The mirror holder 45 holds the mirror bracket 43 and the free mirror bracket 44.

The mirror holder 45 has a box-like shape while the upper side, lower side, and one side such as right side in the X direction in FIG. 12 are opened, and thereby the mirror holder 45 has a U-like shape when viewed from the top. The upper part of the mirror holder 45 includes an inclined portion extending along a direction set between the middle of the X and Y directions by increasing the height, and includes a parallel face parallel to the X direction. The inclined portion is disposed at a proximal side of the parallel face in the X direction. Further, the peripheral side of upper opening of the mirror holder 45 disposed at a proximal side in the X direction and extending in the Z direction is parallel to the Z direction in FIG. 12.

The mirror bracket 43 is attached to the upper part of the mirror holder 45. The mirror bracket 43 includes an inclined side 43a and a horizontal side 43b. The inclined side 43a rises along a direction set between the middle of the X and Y directions by increasing the height as shown in FIG. 12. The horizontal side 43b extends in a direction parallel to the X direction in FIG. 12. The inclined side 43a contacts the peripherals of the inclined portion of the mirror holder 45, and the horizontal side 43b contacts the peripherals of the horizontal part of the mirror holder 45, which is the top of the mirror holder 45. The inclined side 43a includes an opening, and the reflection mirror 41 is retained to cover the opening of the inclined side 43a. The horizontal side 43b includes an opening, and the transparent glass 51 is retained to cover the opening of the horizontal side 43b.

Each end of the reflection mirror 41 in the Z direction is pressed to the inclined side 43a of the mirror bracket 43 by the mirror pressing member 46 such as a leaf spring to hold the reflection mirror 41 at the inclined side 43a of the mirror bracket 43. For example, as shown in FIG. 12, one end of the reflection mirror 41 in the Z direction is fixed by the two mirror pressing members 46, and other end of the reflection mirror 41 in the Z direction is fixed by the one mirror pressing member 46.

Each end of the transparent glass 51 in the Z direction is pressed to the horizontal side 43b of the mirror bracket 43 by a glass pressing member 47 such as a leaf spring to hold the transparent glass 51 on the mirror bracket 43. Each end of the transparent glass 51 in the Z direction is retained by using one glass pressing member 47 at each end in the Z direction.

The free mirror bracket 44 to retain the curved mirror 42 includes an arm portion 44a at each side of the free mirror bracket 44, in which the arm portion 44a extends and inclines along a direction set between the middle of the X and Y directions as shown in FIG. 12. Further, the free mirror bracket 44 includes a link portion 44b that links such two arm portions 44a at the upper portion of the arm portions 44a. The arm portion 44a of the free mirror bracket 44 is attached to the mirror holder 45 so that the curved mirror 42 covers an opening of the mirror holder 45.

The curved mirror 42 pressed toward the link portion 44b of the free mirror bracket 44 by a free mirror pressing member 49 such as a leaf spring at a substantially center of one end side of the transparent glass 51. Further, each end side of the first optical system 70 in the Z direction in FIG. 12 is fixed to the arm portion 44a of the free mirror bracket 44 using a screw.

The second optical unit 40 is stacked and fixed on the lens holder 32 of the first optical unit 30. Specifically, the bottom side of the mirror holder 45 has a bottom face 451 that faces an upper face of the lens holder 32. The bottom face 451 has three screw stoppers 45a1 to 45a3 having tube-like shape, which can be fixed with the first optical unit 30 by screws. FIG. 12 shows the screw stoppers 45a1 and 45a2, and FIG. 5 shows the screw stopper 45a3. The second optical unit 40 is fixed to the first optical unit 30 using screws, in which the screw 48 is inserted into each of the threaded through-holes 32c1 to 32c3 provided for the lens holder 32 of the first optical unit 30, and screwed into each of the screw stoppers 45a1 to 45a3 to fix the second optical unit 40 to the first optical unit 30.

In this configuration, the bottom face of the mirror holder 45 of the second optical unit 40 contacts the positioning protruded members 32d1 to 32d3 of the lens holder 32, by which the second optical unit 40 can be fixed at a correct position in Y direction.

As shown in FIG. 12, when the second optical unit 40 is stacked and fixed on the lens holder 32 of the first optical unit 30, a portion of the projection lens unit 31 that is above the lens holder 32 is encased in the mirror holder 45 of the second optical unit 40. Further, when the second optical unit 40 is stacked and fixed on the lens holder 32, a space is set between the curved mirror 42 and the lens holder 32, and the idler gear 35 (FIG. 9) may be set in such space.

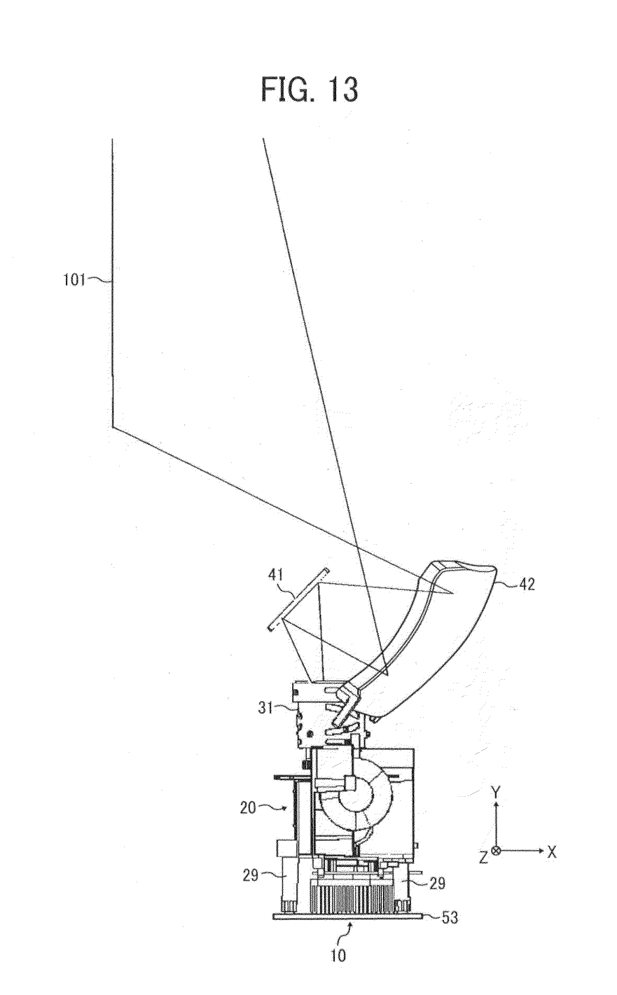

FIG. 13 shows a schematic view of the light path from the first optical system 70 to the projection plane 101 such as a screen. The light flux that has passed through the projection lens unit 31 configuring the first optical system 70 is used to generate an intermediate image between the reflection mirror 41 and the curved mirror 42, which is a conjugate image with respect to an image generated by the DMD 12. Such intermediate image is generated as a curved image between the reflection mirror 41 and the curved mirror 42. Such intermediate image enters the curved mirror 42 having a concave shape, and the curved mirror 42 enlarges the intermediate image and projects the enlarged image onto the projection plane 101.

As above described, an optical projection system can be configured with the first optical system 70, and the second optical system. In this configuration, the intermediate image is generated between the first optical system 70 and the curved mirror 42 of the second optical system, and the intermediate image is enlarged and projected by the curved mirror 42, by which the projection distance to the screen can be set shorter. Therefore, the projector 1 can be used in small meeting rooms or the like.

Further, as shown in FIG. 13, the first optical unit 30 and the second optical unit 40 are stacked and fixed to the lighting unit bracket 26. Further, the image generation unit 10 is fixed to the lighting unit bracket 26. Therefore, the legs 29 of the lighting unit bracket 26 can be fixed to the base member 53 while supporting the weight of the first optical unit 30, the second optical unit 40, and the image generation unit 10.

FIG. 14 schematically shows a layout of units in the projector 1. As shown in FIG. 14, the image generation unit 10, the lighting unit 20, the first optical unit 30, and the second optical unit 40 are stacked along the Y direction, which is the short side direction of the projection plane 101. As shown in FIG. 14, the light source unit 60 is arranged in the Z direction with respect to other stacked units composed of the image generation unit 10, the lighting unit 20, the first optical unit 30, and the second optical unit 40, which is the long side direction of the projection plane 101. As above described, in an example embodiment, the image generation unit 10, the lighting unit 20, the first optical unit 30, the second optical unit 40, and the light source unit 60 can be arranged along the Y direction and Z directions, which are parallel to a projected image and the projection plane 101.

Specifically, the projection optical system B having the first optical unit 30 and the second optical unit 40 is stacked on the image generator A having the image generation unit 10 and the lighting unit 20. The light source unit 60 is coupled to the image generator A in a direction perpendicular to the stacking direction of the image generator A and the projection optical system B. Further, the image generator A and the light source unit 60 can be arranged along a direction parallel to the base member 53. Further, the image generator A and the projection optical system B may be arranged along a direction perpendicular to the base member 53, in which the image generator A is disposed over the base member 53, and then the projection optical system B is disposed over the image generator A. With this configuration, an installation space of the projector 1 in the direction perpendicular to the projection plane 101 used for projecting image can be suppressed. With this configuration, when an image projection apparatus is used in a small room by placing the image projection apparatus on a table, the installation of the image projection apparatus may not cause a problem of a layout of table and chairs.

Further, as shown in FIG. 14, a power source unit 80 is stacked or disposed above the light source unit 60, wherein the power source unit 80 supplies power to the light source 61 and the DMD board 11. The light source unit 60, the power source unit 80, the image generator A, and the projection optical system B are encased in a casing of the projector 1. The casing of the projector 1 includes the top face of the projector 1, the base member 53, and an outer cover 59 (FIG. 19) used as the side face of the projector 1 to be described later.

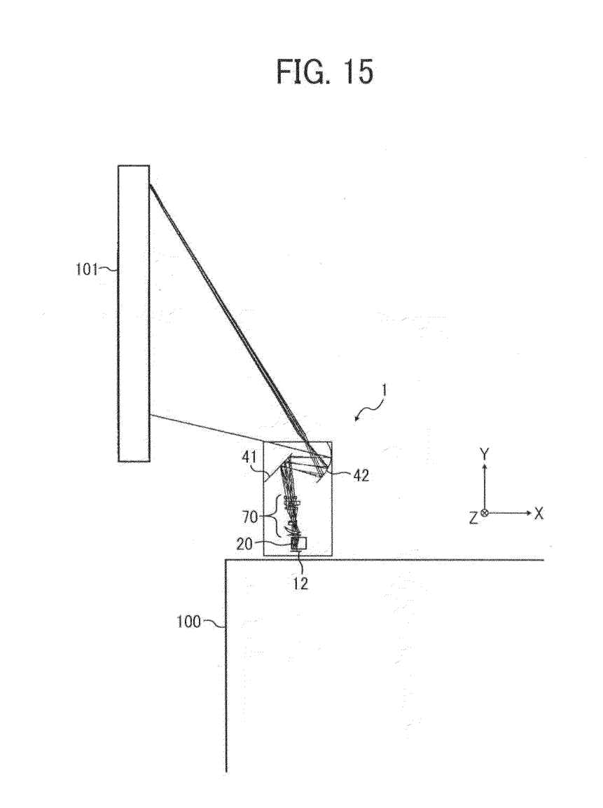

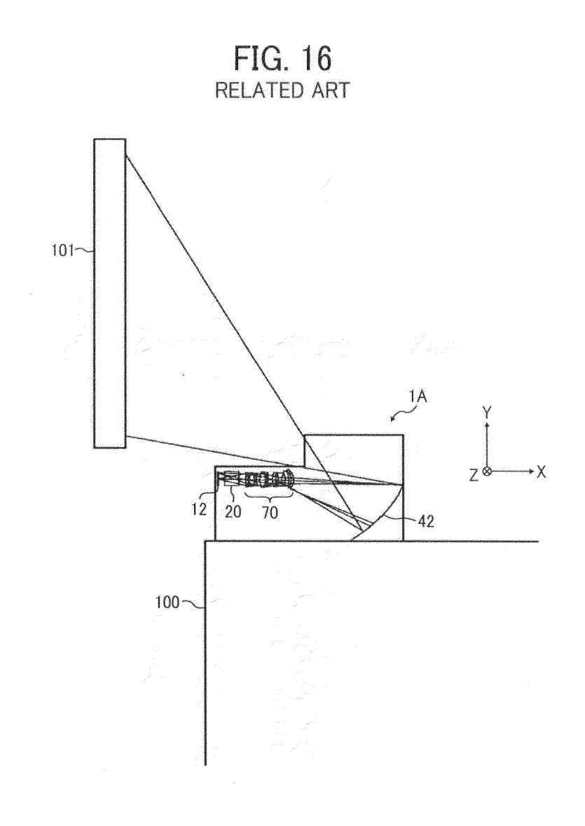

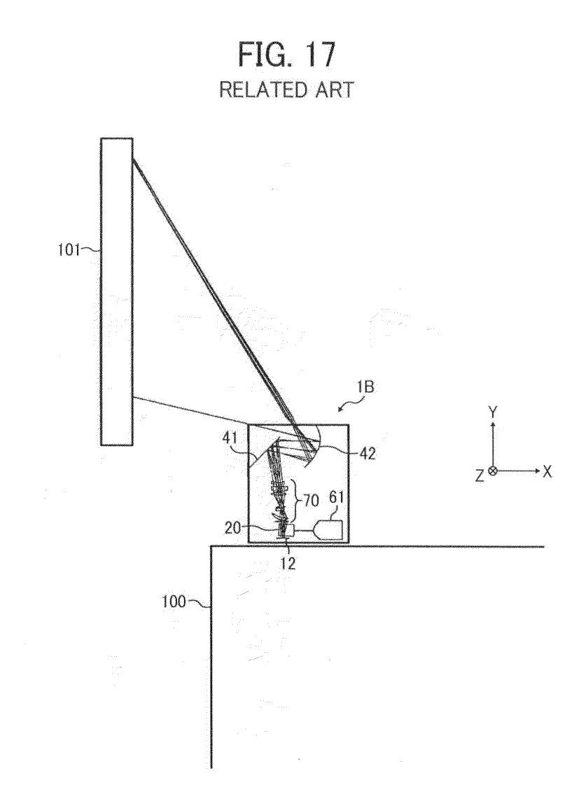

FIG. 15 shows an example of use environment of the projector 1 according to an example embodiment, and FIG. 16 and FIG. 17 show examples of use environment of conventional projectors 1A and 1B. As shown in FIGS. 15 to 17, when the projector is used in a meeting room, the projector may be placed on a table 100, and images are projected on the projection plane 101 such as a white board.

As shown in FIG. 16, as for the conventional projector 1A, the DMD 12, the lighting unit 20, the first optical system 70, and the second optical system such as the curved mirror 42 are serially arranged along in the direction perpendicular to the projection plane 101 to which a projected image is projected. Therefore, the length of the projector 1A in the direction perpendicular to the projection plane 101 (i.e., X direction) becomes longer, and thereby a greater space is required for the projector 1A in the direction perpendicular to the projection plane 101.

Typically, chairs that participants sit and desks that participants use may be arranged in the direction perpendicular to the projection plane 101 when to see images projected on the projection plane 101. Therefore, if a greater space for the projector 1A is required in the direction perpendicular to the projection plane 101, the arrangement space for chairs and the arrangement space for desks are restricted and thereby not convenient when the projector is used.

As shown in FIG. 17, as for the conventional projector 1B, the DMD 12, the lighting unit 20, and the first optical system 70 are serially arranged along in a direction parallel to the projection plane 101 to which a projected image is projected. Therefore, compared to the projector 1A shown in FIG. 16, the length of the projector 1B in the direction perpendicular to the projection plane 101 can be set shorter. However, as for the projector 1B of FIG. 17, the light source 61 is arranged in the direction perpendicular to the projection plane 101 and is arranged after the lighting unit 20 in the direction perpendicular to the projection plane 101, and thereby the length of the projector 1B in the direction perpendicular to the projection plane 101 may not be effectively set shorter.

As for the projector 1 of an example embodiment shown in FIG. 15, the image generator A having the image generation unit 10 and the lighting unit 20, and the projection optical system B having the first optical unit 30 and the reflection mirror 41 are serially arranged along in a direction parallel to the projection plane 101, to which a projected image is projected. In this configuration, the image generator A and the projection optical system B are serially arranged along in a direction parallel to the Y direction in FIG. 15. Further, the light source unit 60 and the lighting unit 20 are serially arranged along in a direction parallel to the projection plane 101, which means the light source unit 60 and the lighting unit 20 are serially arranged along the Z direction in FIG. 15.

As above described, as for the projector 1 according to an example embodiment, the light source unit 60, the image generation unit 10, the lighting unit 20, the first optical unit 30, and the reflection mirror 41 can be arranged in a direction parallel to the projection plane 101 such as the Z direction or Y direction in FIG. 15. As above described, the light source unit 60, the image generation unit 10, the lighting unit 20, the first optical unit 30, and the reflection mirror 41 can be arranged in a direction parallel to the projection plane 101 such as the Z direction or Y direction in FIG. 15. Therefore, the length of the projector 1 in the direction perpendicular to the projection plane 101 (i.e., X direction in FIG. 15) can be set shorter than the length of the projectors 1A and 1B shown in FIGS. 16 and 17. With this configuration, the projector 1 may not cause problems when arranging a space for chairs and desks, by which the projector 1 having a good enough level of convenience can be devised.

Further, as shown in FIG. 14, the power source unit 80 is stacked or disposed above the light source unit 60 to supply power to the light source 61 and the DMD board 11, by which the length of the projector 1 in the Z direction can be set shorter.

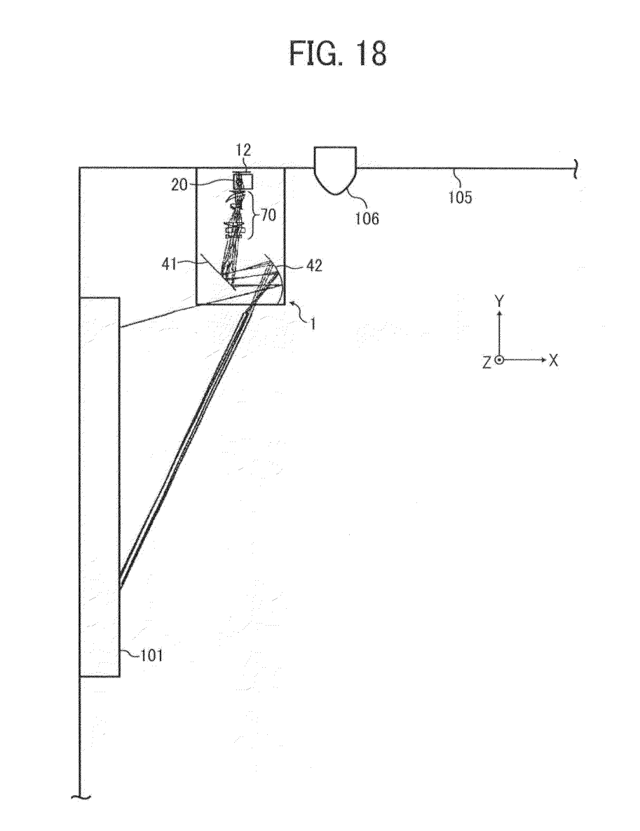

FIG. 18 shows another example use of the projector 1 according to an example embodiment. As shown in FIG. 18, the projector 1 can be fixed on a ceiling 105. Because the projector 1 has a short side in the direction perpendicular to the projection plane 101, the projector 1 can be fixed on the ceiling 105 without interference with a lighting device 106 disposed on the ceiling 105.

Further, although the second optical system may be configured with the reflection mirror 41 and the curved mirror 42, but the second optical system can be configured with only the curved mirror 42. Further, the reflection mirror 41 can be a plane minor, a mirror having a positive refractive power, and a mirror having a negative refractive power. Further, the curved mirror 42 may be a concave minor or a convex mirror. When the curved mirror 42 is a convex mirror, the first optical system 70 is configured in a way so that no intermediate image is generated between the first optical system 70 and the curved mirror 42.

Because the light source 61 has a lifetime for effective use, the light source 61 is required to be replaced with a new one periodically. Therefore, the light source unit 60 is detachably attached to a body of the projector 1.

FIG. 19 shows a perspective view of the projector 1 viewed from a bottom face of the projector 1, wherein the bottom face may be placed on a table. As shown in FIG. 19, the bottom face of the projector 1 includes the base member 53 and the cover 54. The cover 54 includes a rotate-able member 54a. When the rotate-able member 54a is rotated, the cover 54 is unlocked from the body of the projector 1, by which the cover 54 can be removed from the body of the projector 1. Further, the base member 53 includes, for example, a power-source air intake port 56 at a position next to the cover 54 in the X direction.

Further, as shown in FIG. 19, an air-intake port 84 and the input unit 88 are disposed on one Y-X plane of the outer cover 59 of the projector 1. The input unit 88 is used to input image data from external apparatuses such as personal computers.

FIG. 20 shows a perspective view of the projector 1 when the cover 54 is removed from the projector 1. When the cover 54 is removed, the light-source bracket 62 of the light source unit 60 is exposed, wherein the exposed side is the opposite side that the light source 61 is attached. The light-source bracket 62 includes a knob 66, which is pivotable about the pivot center O1 indicated by a dotted line in FIG. 20.

When removing the light source unit 60 from the body of the projector 1, the knob 66 is pivoted and opened by picking the knob 66, by which the light source unit 60 can be removed from an opening of the body of the projector 1. When attaching the light source unit 60 into the body of the projector 1, the light source unit 60 is inserted into the body of the projector 1 through the opening. When the light source unit 60 is inserted into the body of the projector 1, the connector 62a (FIG. 4) is connected with a power-source connector in the body of the projector 1, and the three light source position-setting members 64a1 to 64a3 of the holder 64 (FIG. 4) engage with three light source positioning members 26a1 to 26a3 (FIG. 6) disposed for the lighting unit bracket 26 of the lighting unit 20, by which the light source unit 60 is set at a correct position in the body of the projector 1, and the attachment of the light source unit 60 completes. Then, the cover 54 is attached to the base member 53.

As above described, the knob 66 is provided for the light source unit 60, but the pass-through area 65 shown in FIG. 20, which protrudes to the cover 54, can be used as a knob. The pass-through area 65 may be also referred to as the duct 65. The cover 54 will be described later in detail,

Further, the base member 53 is disposed with three legs 55. By rotating the legs 55, the protruded length of the legs 5 from the base member 53 can be changed, by which the height adjustment in the Y direction of the projector 1 can be conducted.

Further, as shown in FIG. 20, an exhaust port 85 is disposed at other Y-X plane of the outer cover 59.

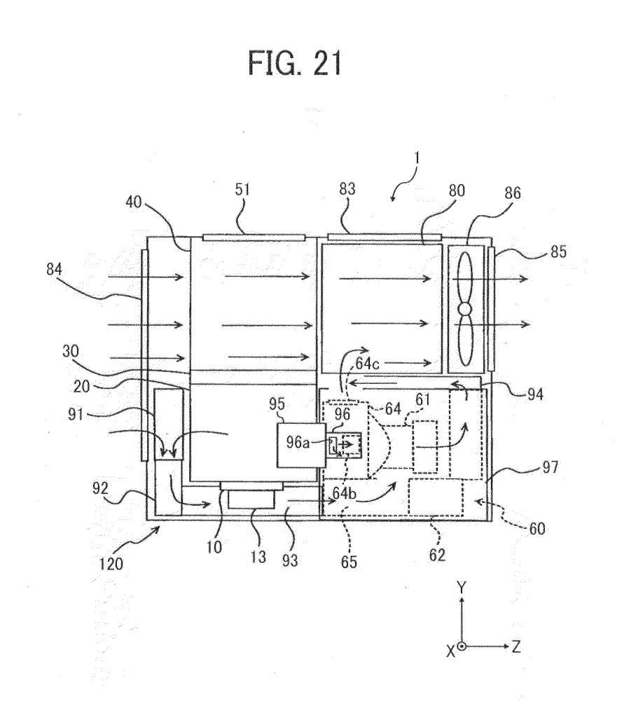

FIG. 21 shows a schematic view of airflow in the projector 1 according to an example embodiment. FIG. 21 shows the projector 1 viewed from the X direction, wherein the X direction is perpendicular to the projection plane 101. As shown in FIG. 21, the projector includes the air-intake port 84 disposed its one face (left side in FIG. 21), and the exhaust port 85 disposed its other face (right side in FIG. 21). The air-intake port 84 has an opening to intake external air into the projector 1. The exhaust port 85 has an opening to exhaust air from the projector 1. Further, an exhaust fan 86 is disposed at a position facing the exhaust port 85.

When the projector 1 is viewed from the X direction, which is a direction perpendicular to the projection plane 101, a part of the exhaust port 85 and a part of the air-intake port 84 may be disposed between the light source unit 60 and the operation unit 83. Further, a flow path is set between a rear face of the curved mirror 42 and the outer cover 59 facing the rear face of the curved minor 42 so that air can flow in this space. With this configuration, the external air taken from the air-intake port 84 can flow through along the Z-Y plane of the mirror holder 45 of the second optical unit 40 (FIG. 12), and the rear face of the curved mirror 42 by following the mirror holder 45 and curving of the rear face of the curved mirror 42, and then flow to the exhaust port 85. Further, the curved mirror 42 is a concave mirror having the positive refractive power as above mentioned, and thereby the rear face of the curved mirror 42 has a convex shape.

Further, the power source unit 80 has a configuration having three sides. Therefore, when the power source unit 80 disposed over the light source unit 60 is viewed from the Z direction in FIG. 21, the power source unit 80 can be viewed as a U-shape configuration without a side facing the light source unit 60. Further, the external air taken from the air-intake port 84 flows along the mirror holder 45 and the curving of the rear face of the curved mirror 42 toward the exhaust port 85, and then further flows to a space encircled by the power source unit 80 having the three sides, and is then exhausted from the exhaust port 85.

As above described, the part of the exhaust port 85 and the air-intake port 84 are disposed between the light source unit 60 and the operation unit 83 when the projector 1 is viewed from the X direction, which is a direction perpendicular to the projection plane 101. In this configuration, an airflow passing through a space between the light source unit 60 and the operation unit 83 and exhausted from the exhaust port 85 can be generated.

Further, a light source blower 95 is disposed at a position that can suck air around the color motor 21a (FIG. 5) that drives the color wheel 21 in the lighting unit 20. With this configuration, the color motor 21a and the light tunnel 22 can be cooled using the airflow generated by the air sucking effect of the light source blower 95.

The air sucked in by the light source blower 95 passes a light source duct 96, and then flows into a light-source air supply port 64b (FIG. 4) of the holder 64. Further, a part of the air flowing into the light source duct 96 flows into a space between a light source housing 97 and the outer cover 59 from an opening 96a formed on a face of the light source duct 96 opposing the outer cover 59 (FIG. 19).

The air flowing into the space between the light source housing 97 and the outer cover 59 from the opening 96a of the light source duct 96 cools the light source housing 97 and the outer cover 59, and is then exhausted from the exhaust port 85 using the exhaust fan 86.

Further, the air flowing to the light-source air supply port 64b flows into the light source 61 to cool the light source 61, and is then exhausted from the light-source air exhaust port 64c disposed on the top face of the holder 64. The air exhausted from the light-source air exhaust port 64c is then exhausted from an opening formed on the top face of the light source housing 97 to a space encircled by the power source unit 80. Then, the air exhausted from the light source housing 97 (i.e., high-temperature air) is mixed with external air (i.e., low-temperature air) that flows around the second optical unit 40 and then flows into the space encircled by the power source unit 80, and then the mixed air is exhausted from the exhaust port 85 using the exhaust fan 86.

As above described, the high-temperature air exhausted from the light-source air exhaust port 64c is mixed with the external air (i.e., low-temperature air), and then exhausted from the exhaust port 85. Therefore, exhausting of the high-temperature air from the exhaust port 85 can be prevented, and the temperature of air exhausted from the exhaust port 85 can be decreased to a lower temperature.

Further, the operation unit 83 is preferably disposed on a top face of the projector 1 so that the user can operate the operation unit 83 easily. Because the projector 1 includes the transparent glass 51 on its top face for projecting images on the projection plane 101, the operation unit 83 may be disposed on a position corresponding to the light source 61 when viewing the projector 1 from the Y direction.

As above described, the low-temperature air, flowing through a space between the light source unit 60 and the operation unit 83 from the air-intake port 84 toward the exhaust port 85, can be used to cool the high-temperature air, which has become high temperature when the air has cooled the light source 61, by which the low-temperature air and high-temperature air become mixed air. Such mixed air is then exhausted from the exhaust port 85, and thereby the movement of high temperature air to the operation unit 83 can be prevented.

With this configuration, the temperature increase of the operation unit 83, which may be caused by the high temperature air coming from the light source 61, can be prevented. Further, a part of air, flowing from the air-intake port 84 to the exhaust port 85, flows around the second optical unit 40 and then under the operation unit 83 to cool the operation unit 83. Therefore, the temperature increase of the operation unit 83 can be prevented.

Further, when the exhaust fan 86 sucks in air, external air can be sucked from the power-source air intake port 56 disposed on the base member 53 (FIG. 19). A ballast board to supply power or current to the light source 61 is disposed at a position distal of the light source housing 97 in the X direction of FIG. 21. The external air sucked from the power-source air intake port 56 can flow through a space between the light source housing 97 and the ballast board in the upward direction to cool the ballast board. Then, the air flows to a space encircled by the power source unit 80 disposed over the ballast board, and is then exhausted from the exhaust port 85 using the exhaust fan 86.

In an example embodiment, a fan to generate the airflow from the air-intake port 84 to the exhaust port 85 is disposed at an exhaust side, in which the exhaust fan 86 is used as a fan. If the fan is provided at the exhaust side, the air supply volume from the air-intake port 84 into the projector 1 can be set greater than a fan disposed near the air-intake port 84.

If the fan is disposed near the air-intake port 84, the flow rate of external air supplied into the projector 1 may be decreased because the second optical unit 40 exists in a direction that the fan supplies air.

In contrast, if the fan such as the exhaust fan 86 is disposed near the exhaust port 85, the flow rate exhausted from the exhaust fan 86 may not decrease because objects may not exist outside the exhaust port 85. Therefore, when a given volume of air is exhausted from the exhaust fan 86, the same volume of air can be taken from the air-intake port 84, by which the air volume supplied from the air-intake port 84 into the projector 1 may not decrease. Therefore, the air can flow from the air-intake port 84 toward the exhaust port 85 at a given wind pressure, by which hot air rising from the light source 61 can effectively flow to the exhaust port 85 using the air flow flowing from the air-intake port 84 toward the exhaust port 85.

Further, a cooling unit 120 to cool the heat sink 13 of the image generation unit 10 and the light-source bracket 62 of the light source unit 60 is disposed at the lower left side of the projector 1 as shown in FIG. 21. The cooling unit 120 includes, for example, an air-intake blower 91, a vertical duct 92 disposed under the air-intake blower 91, and a horizontal duct 93 connected at the bottom of the vertical duct 92. A description is given of air flows supplied from the air-intake blower 91. The air-intake blower 91 is disposed at a lower side of the air-intake port 84 while facing the air-intake port 84. The air-intake blower 91 sucks external air from the air-intake port 84 via a side face of the air-intake blower 91 facing the air-intake port 84, and also sucks air from the body of the projector 1 from another side, opposite the side face of the air-intake blower 91 facing the air-intake port 84. The sucked air flows in the vertical duct 92 disposed under the air-intake blower 91. The air flowing into the vertical duct 92 flows downward, and then flows to the horizontal duct 93 connected at the bottom of the vertical duct 92.

As shown in FIG. 21, the heat sink 13 is present in the horizontal duct 93. Therefore, the heat sink 13 can be cooled by the air flowing in the horizontal duct 93. By cooling the heat sink 13, the DMD 12 can be cooled effectively and efficiently, by which high temperature of the DMD 12 can be prevented.

The air flowing through the horizontal duct 93 flows into the pass-through area 65 (duct 65) or the opening 65a disposed for the light-source bracket 62 of the light source unit 60 (FIG. 4). The air flowing into the opening 65a flows through a space between the cover 54 and the light-source bracket 62, and cools the cover 54.

Meanwhile, the air flowing into the pass-through area 65 cools the light-source bracket 62, and then flows into a space opposite the light exit side of the light source 61 to cool a face of a reflector 67 so that the reflector 67 of the light source 61 is cooled, in which the face of the reflector 67 cooled by the air is a face opposite the reflection face of the reflector 67. Therefore, the air that passes through the pass-through area 65 can take heat from both of the light-source bracket 62 and the light source 61.

The air, which has passed near the reflector 67, passes through an exhaust duct 94, which is used to guide the air from the top side of the light-source bracket 62 to the lower side of the exhaust fan 86, and then converges into the air exhausted from the light-source air exhaust port 64c, and then flows to the exhaust port 85, and then the air can be exhausted from the exhaust port 85 using the exhaust fan 86.

Further, the air flowing into a space between the cover 54 and the light-source bracket 62 through the opening 65a cools the cover 54, and then flows inside the projector 1, and is then exhausted from the exhaust port 85 using the exhaust fan 86.

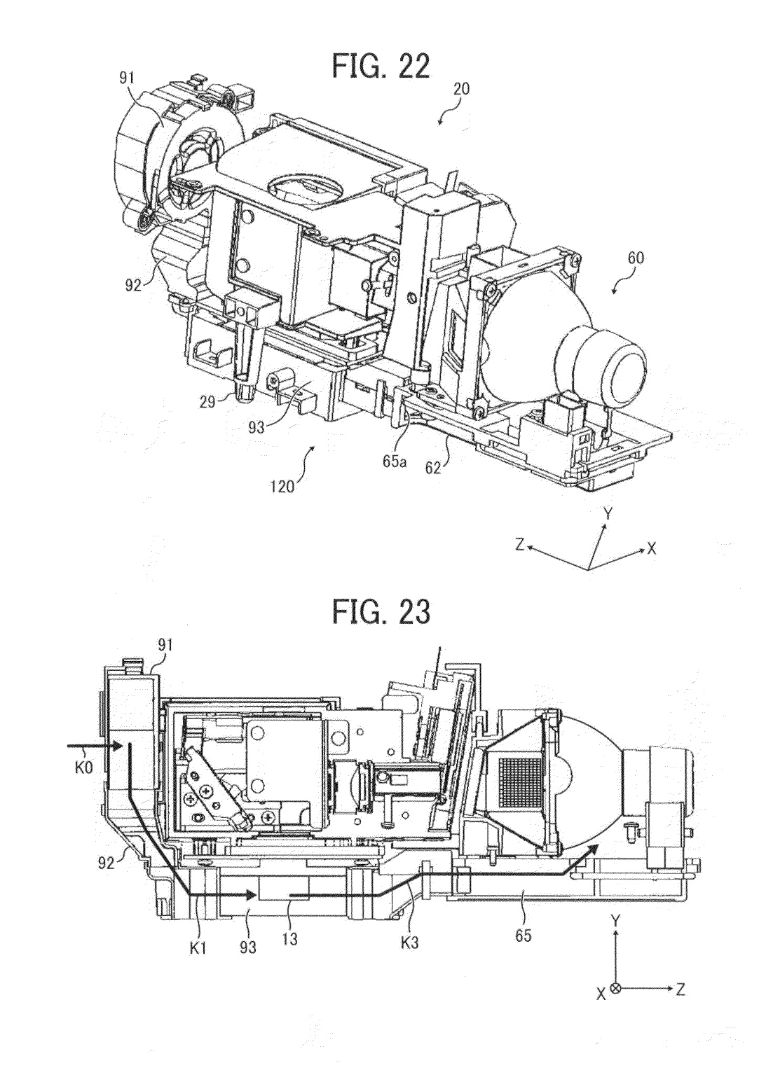

FIG. 22 shows a perspective view of the cooling unit 120, the lighting unit 20, and the light source unit 60, which shows a positional relationship of the cooling unit 120, the lighting unit 20, and the light source unit 60. As shown in FIG. 22, the legs 29 that support the weight of the image generation unit 10 of the lighting unit 20, the first optical unit 30, and the second optical unit 40 can be used to secure a space for disposing the horizontal duct 93 under the lighting unit 20.

FIG. 23 shows a cross-sectional view of FIG. 22, in which arrows indicate airflow from the air-intake blower 91 to the reflector 67 via the pass-through area 65. The air taken in from the air-intake blower 91 can flow along the arrows K0, K1, and K3 as shown in FIG. 23. The light source bracket 62 and the pass-through area 65 are disposed in the projector 1 while facing the base member 53, in which the horizontal duct 93 used as an air flow path to cool the reflector 67 of the light source 61 and also used as an air flow path to cool the heat sink 13 is disposed on the base member 53, by which the width of the projector 1 perpendicular to the projection plane can be set shorter.

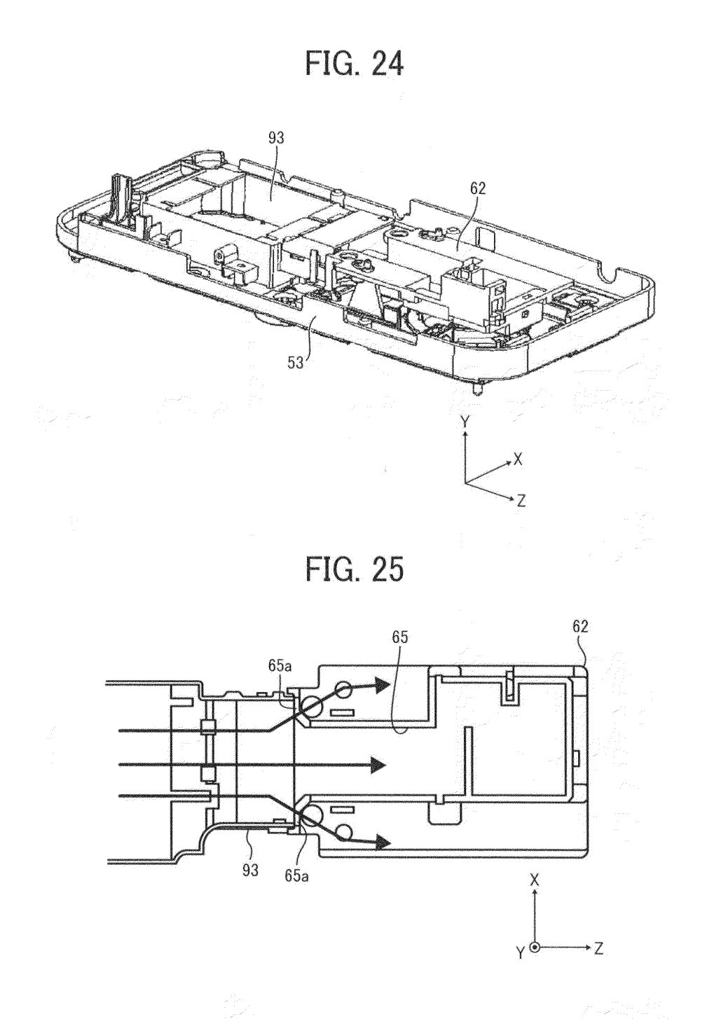

FIG. 24 shows a perspective view of the base member 53, the horizontal duct 93, and the light source bracket 62. As shown in FIG. 24, the horizontal duct 93 is fixed on the base member 53 of the projector 1, and a part of the upper side of the horizontal duct 93 is opened. The image generation unit 10 is disposed above the horizontal duct 93 while the heat sink 13 of the image generation unit 10 is fit in the opening of the horizontal duct 93.

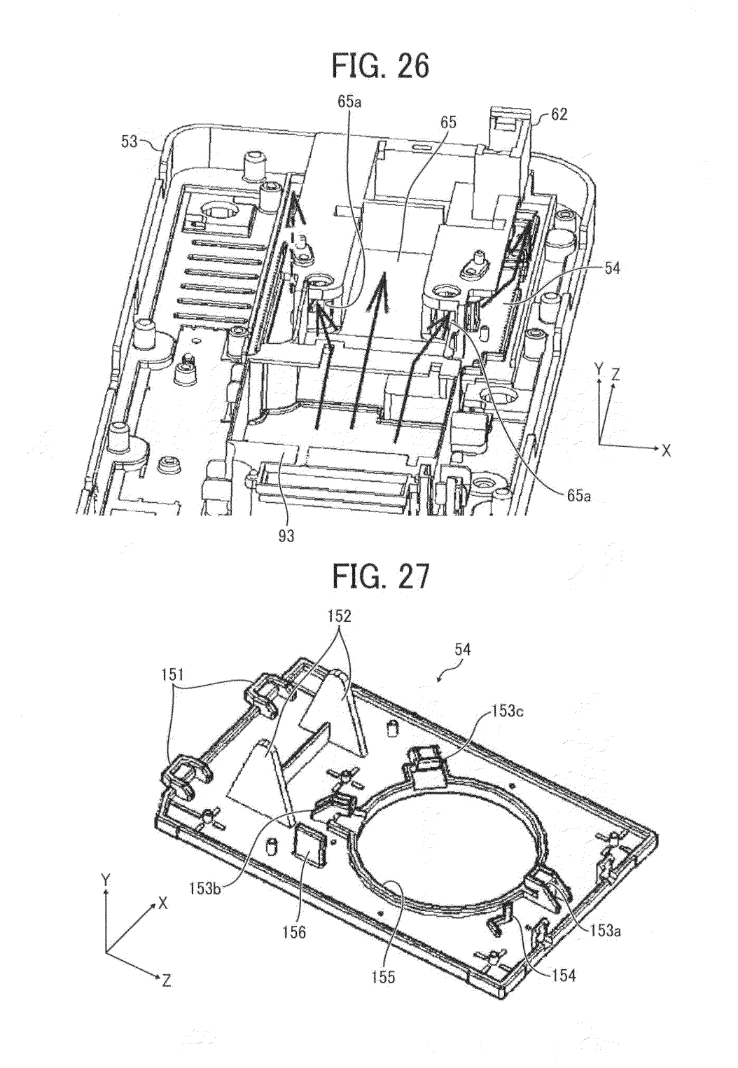

FIG. 25 shows routes of airflow from the horizontal duct 93 to the light source bracket 62 viewed from the lower side, and FIG. 26 shows the routes of airflow from the horizontal duct 93 to the light source bracket 62 viewed from the upper side. As shown in FIGS. 25 and 26, the air moving inside the horizontal duct 93 flows in the pass-through area 65 or the opening 65a disposed for the light source bracket 62 of the light source unit 60. The air taken in from the opening 65a flows through a space between the cover 54 and the light source bracket 62 to cool the cover 54, by which the air can take heat from the cover 54. Further, the heat of the pass-through area 65 can be taken by the air flowing to the light source 61 and the air flowing around the cover 54.

Because the light source 61 employs, for example, a halogen lamp, a metal-halide lamp, or a high-pressure mercury vapor lamp, the light source 61 becomes hot when the light source 61 emits light. The light source bracket 62 and the cover 54 become hot due to the heat conduction and radiant heat from the light source 61. When the light source 61 ends its lifetime, the light source unit 60 is replaced, in which the cover 54 and the light source bracket 62 are picked by a hand, and thereby the replacement work of the light source unit 60 can be conducted when the temperature of the cover 54 and the light source bracket 62 becomes low. If the temperature is still high, the replacement of the light source unit 60 cannot be conducted.

In the above described example embodiment, the pass-through area 65 is disposed for the light source bracket 62, and the air flows in the pass-through area 65 to cool the light source bracket 62, and the air flows between the cover 54 and the light source bracket 62 to cool the cover 54. With this configuration, a temperature increase of the cover 54 and the light source bracket 62 can be suppressed, and thereby the temperature of the cover 54 and the light source bracket 62 can be decreased to a temperature that a user can touch and pick the closable cover 54 and the light source bracket 62 after stopping the operation of the projector 1 within a short period of time. Therefore, if the light source 61 ends its lifetime when the projector 1 is being used and the replacement of the light source unit 60 is required, the user can pick the cover 54 or the knob 66 after stopping the operation of the projector 1 within the short period of time. Therefore, the light source unit 60 can be replaced with a new one faster than conventional configurations, by which the downtime of the projector 1 can be shortened.

Further, the pass-through area 65 can be protruded toward the cover 54, by which the pass-through area 65 can be used as a knob that a user can pick the pass-through area 65 when the light source unit 60 is replaced. As above described, the pass-through area 65 can be actively cooled by a flow of taken-in air, and thereby the temperature of the pass-through area 65 can be set lower than other part of the light source bracket 62. Therefore, if the pass-through area 65 is configured as a knob, the light source unit 60 can be replaced with a new one at a further earlier timing, by which the downtime of the projector 1 can be shortened further.

Further, as above described, the light-source bracket 62 can be cooled by providing the pass-through area 65 for the light-source bracket 62. By cooling the light-source bracket 62, the temperature increase of the light source 61 can be suppressed, in particular prevented. Therefore, the light source 61 can be cooled effectively even if the flow rate of cooling air flowing into the light source 61 is decreased. If the flow rate of cooling air is decreased, the revolutions per minute (rpm) of the light source blower 95 can be decreased, by which a wind noise of the light source blower 95 can be decreased and the noise generation of the projector 1 can be suppressed. Further, by decreasing the revolutions per minute (rpm) of the light source blower 95, the power-saving of the projector 1 can be enhanced. Further, by using the smaller light source blower 95 that supplies lower amount of wind air, the projector 1 can be configured compact in size.

Further, as for the projector 1, the cover 54 includes a push member that can push the light source unit 60 toward inside the projector 1. The push member of the cover 54 is used to push the light source unit 60 to fix the light source unit 60 into the projector 1. A description is given of the push member with reference to drawings. The push member may include, for example, a first push member and a second push member.

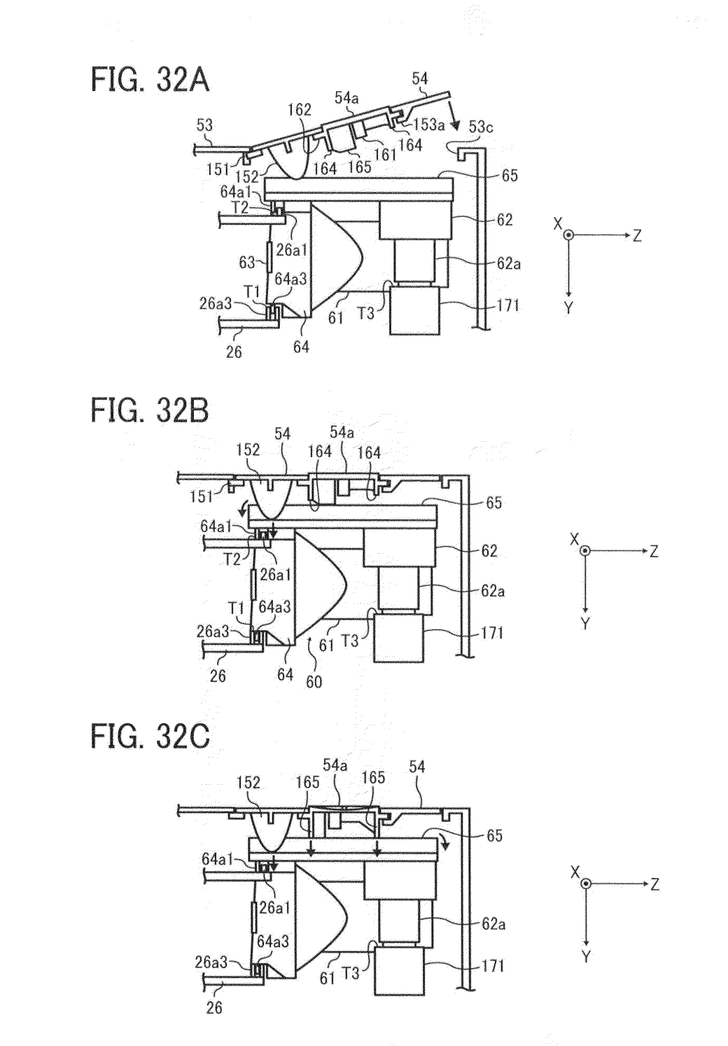

FIG. 27 shows a perspective view of the cover 54. As shown in FIG. 27, the cover 54 has an opening 155 to which a rotate-able member 54a is attached. Claws 153a to 153c are disposed at three positions along the peripheral of the opening 155 to attach the rotate-able member 54a rotatably on the cover 54. Further, two hook members 151 are disposed at one side of the cover 54 (left side in FIG. 27), wherein the hook members 151 are hooked to a peripheral of a light source replacement opening 53c (FIG. 32), which is an opening of the base member 53.

Further, a pushing protrusion 152, which may be a pair of protrusions, is disposed between the hook member 151 and the opening 155 as a second push member. The pushing protrusion 152 can contact the both sides of the pass-through area 65 of the light source bracket 62, and push the light source unit 60 to an attachment direction of the light source unit 60.

Further, a displacement preventing member 154 is disposed near the peripheral of the opening 155 (right side in FIG. 27) to prevent a displacement of the rotate-able member 54a from the cover 54. Further, a contact member 156 is disposed near the peripherals of the opening 155 at the pushing protrusion 152 side. When the rotate-able member 54a comes to a unlock position of the cover 54, the contact member 156 contacts a lock member 161 of the rotate-able member 54a.

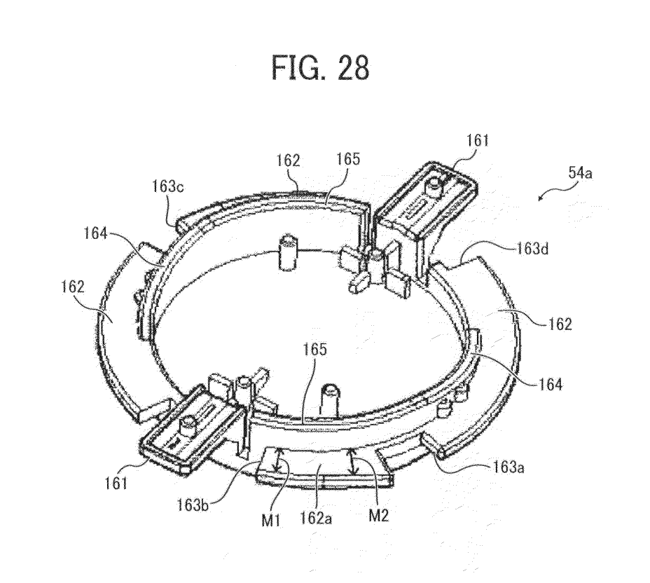

FIG. 28 shows a perspective view of the rotate-able member 54a. As shown in FIG. 28, a base portion of the rotate-able member 54a has a circular shape having a diameter smaller than a diameter of the opening 155 so that the rotate-able member 54a can fit in the opening 155 of the cover 54. The rotate-able member 54a includes two lock members 161 disposed at opposite positions with each other, and a flange 162 as shown in FIG. 28. The two lock members 161 can be used to lock the cover 54 on the base member 53. The flange 162 having a given width is formed along the circumferential direction of the rotate-able member 54a, in which the flange 162 protrudes outward as shown in FIG. 28. The flange 162 is provided with, for example, four cutouts 163 at four positions along the circumferential direction.

Further, as for the flanges 162, when the rotate-able member 54a is attached to the cover 54, the displacement preventing member 154 faces a flange 162a shown in FIG. 28. As shown in FIG. 28, the flange 162a has a first width M1 at one end and a second width M2 at other end, in which the second width M2 is greater than the first width M1, and the width of the flange 162a becomes gradually greater from the first width M1 to the second width M2. The second width M2 is greater than other width at other positions of the flange 162a.

A push member 165, which can be used as a first push member, is disposed, for example, at two positions of circumference of the rotate-able member 54a as shown in FIG. 28, in which one push member 165 is disposed near one lock member 161 and another push member 165 is disposed near another lock member 161. The push member 165 protrudes toward the light source unit 60 (upper direction in FIG. 28). When the cover 54 is locked on the base member 53, the push member 165 contacts and pushes the pass-through area 65 or duct 65 provided to the light source bracket 62, by which the light source unit 60 is pushed or pressed to the attachment direction of the light source unit 60, in which the pass-through area 65 can be pushed or pressed at two position distanced with each other by the push member 165. The push member 165 is formed as a slope 164, wherein the slope 164 is formed along the rotation direction of the rotate-able member 54a, and the slope 164 extends between the upstream and downstream of the rotation direction of the rotate-able member 54a gradually increasing its height in a direction toward the light source unit 60. The rotate-able member 54a can be rotated from the unlock position to the lock position in the counter-clock direction in FIG. 28.

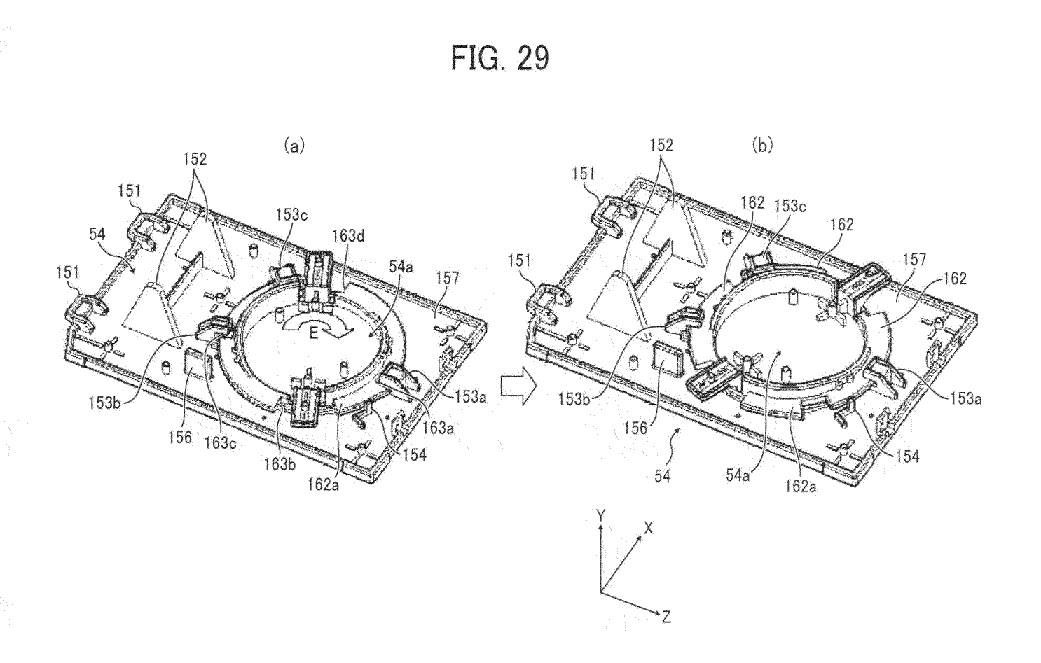

FIG. 29 shows a perspective view of attachment of the rotate-able member 54a to the cover 54. The rotate-able member 54a is attached to the opening 155 of the cover 54 as follows. Initially, as shown in FIG. 29(a), the cutout 163a of the rotate-able member 54a is set at the claw 153a position, the cutout 163c is set at the claw 153b position, and the cutout 163d is set at the position of the claw 153c, by which the rotate-able member 54a is attached to the opening 155 of the cover 54. With this configuration, the rotate-able member 54a can be attached to the opening 155 of the cover 54 without interference between the flange 162 and the claws 153a to 153c. Further, when the rotate-able member 54a is attached to the opening 155, the one end of the flange 162a faces the displacement preventing member 154.

Upon attaching the rotate-able member 54a in the opening 155 of the cover 54, the rotate-able member 54a is rotated in the clockwise direction shown by an arrow E in FIG. 29. Then, the flange 162 is inserted between the claws 153a to 153c and a base face 157 of the cover 54. Further, the flange 162a contacts the displacement preventing member 154. When a force is applied from this condition to rotate the rotate-able member 54a, the displacement preventing member 154 can deform elastically, by which the flange 162a can move over the displacement preventing member 154. With this configuration, as shown in FIG. 29(b), the rotate-able member 54a can be rotatably attached to the cover 54. Because the displacement preventing member 154 is disposed at a position that does not contact other flanges 162, the displacement preventing member 154 does not cause an operation resistance when the rotate-able member 54a is operated to unlock or lock the cover 54.

When the rotate-able member 54a is rotated from the position shown in FIG. 29(b) to the counter-clockwise direction in FIG. 29(b), the displacement preventing member 154 contacts the other end of the flange 162a, by which the displacement preventing member 154 limits the rotation of the rotate-able member 54a. With this configuration, the cutouts 163a, 163c and 163d of the rotate-able member 54a are not rotated to the positions facing the claws 153a, 153b and 153c respectively, by which a drop of the rotate-able member 54a from the cover 54 can be prevented after attaching the rotate-able member 54a to the cover 54.

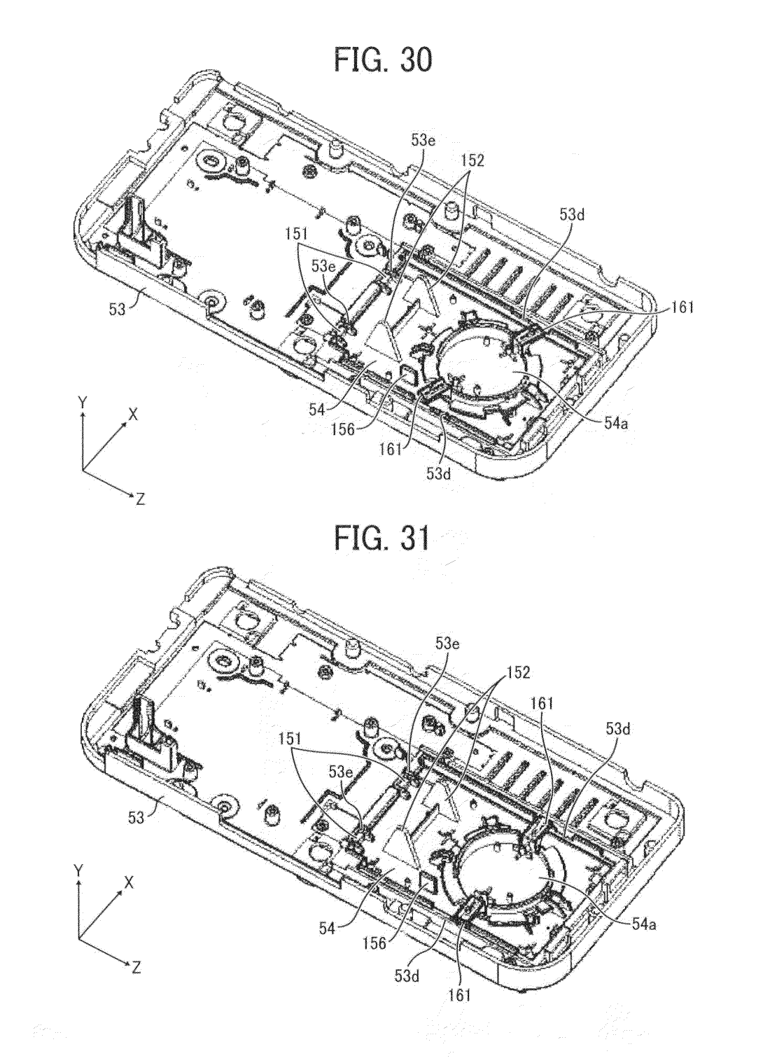

A description is given of attachment of the cover 54 to the base member 53 of the projector 1. FIG. 30 shows a perspective view of the base member 53 when the cover 54 is attached to the light source replacement opening 53c of the base member 53. As shown in FIG. 30, the peripheral of the light source replacement opening 53c of the base member 53 projects upward, and a notch 53d is provided at a position facing the lock member 161 of the rotate-able member 54a. Further, the peripheral of the light source replacement opening 53c at the left side of FIG. 30 has two cutouts to provide a hook receiver 53e used for hooking the hook members 151 of the cover 54.

Further, the cover 54 can be more likely deformed elastically compared to the contact member disposed in the lighting unit bracket 26 and a power source side connector 171 when the light source unit 60 is installed in the projector 1.

When the rotate-able member 54a is at the unlock position, the lock member 161 is not in the notch 53d. When locking the cover 54 to the base member 53, the rotate-able member 54a is rotated from the unlock position into the counter-clockwise direction in FIG. 30.

FIG. 31 shows a perspective view of the base member 53 when the cover 54 is locked to the light source replacement opening 53c of the base member 53. When the rotate-able member 54a is at the lock position, the lock member 161 is in the notch 53d. With this configuration, the rotate-able member 54a comes to the lock position that locks the cover 54 to the base member 53, and the cover 54 is locked to the base member 53. Further, when the rotatable member 54a is moved and set at the lock position, the lock member 161 contacts an end of the notch 53d with an impact. With this impact feeling, a user that operates the rotate-able member 54a can be informed that the rotate-able member 54a is set at the lock position.

FIG. 32 shows a process of locking the cover 54 to the light source replacement opening 53c of the base member 53. As shown in FIG. 32A, when the light source unit 60 is installed in the projector 1, the light source position-setting members 64a1, 64a2, and 64a3 disposed for the holder 64 of the light source unit 60 respectively engage the light source positioning members 26a1, 26a2, and 26a3 disposed for the light source bracket 62, and further the connector 62a of female type engages the power source side connector 171 of male type. With this configuration, the light source unit 60 can be fixed in the projector 1 in the Z direction and the X direction.

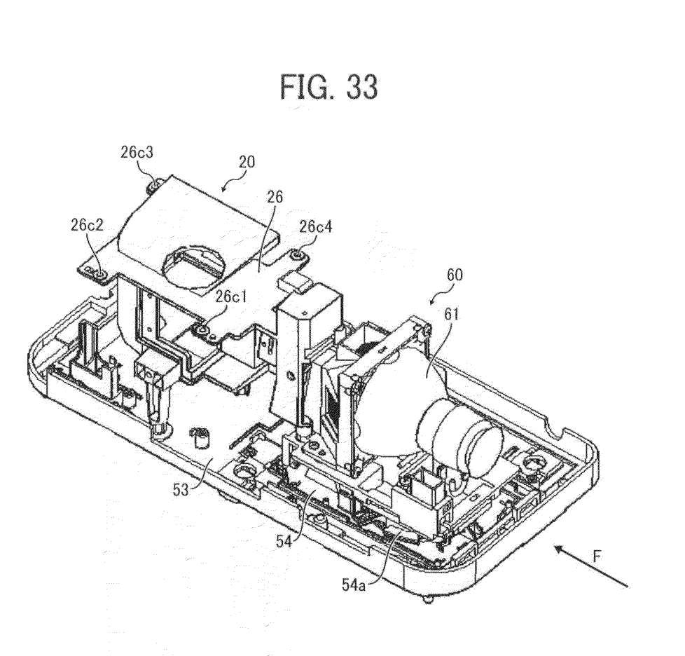

The cover 54 can be attached to the light source replacement opening 53c of the base member 53 as follows. Initially, the hook members 151 are hooked to the hook receiver 53e, and then the cover 54 is pivoted into the clockwise direction in FIG. 32A using the hook members 151 as a fulcrum. As the cover 54 is swung, the pushing protrusion 152 disposed near the hook members 151 can contact the both lateral sides of the pass-through area 65 provided for the light source bracket 62. By further swinging the cover 54, the pushing protrusion 152 pushes the holder 64 of the light source unit 60, by which the plane face portion 64d2 (FIG. 4) having the light source position-setting member 64a3 for the holder 64 of the light source unit 60 contacts an end portion T1 of the light source positioning member 26a3 disposed as a contact member for the lighting unit bracket 26. Further, the plane face portion 64d1 (FIG. 4) for the light source position-setting members 64a1 and 64a2 for the holder 64 contacts a face T2 having the light source positioning members 26a1 and 26a2 for the lighting unit bracket 26, in which the face T2 can be used as a contact member. With this configuration, the holder 64 of the light source unit 60 can be sandwiched and fixed by the pushing protrusion 152 and the lighting unit 20. Then, as shown in FIG. 32B, the cover 54 is attached to the light source replacement opening 53c. FIG. 33 shows a perspective view of the lighting unit 20 and the light source unit 60 installed on the base member 53.

The cover 54 can be attached to the light source replacement opening 53c as above described. The pushing protrusion 152 is disposed near the hook members 151 used as the fulcrum when the cover 54 is pivoted, in which the hook members 151 are used as the fulcrum of the principle of leverage, the contact point of the pushing protrusion 152 and the light source unit 60 is used as the point of application of lever, and an end of the cover 54 opposite to the hook member 151 is used as the point of effort of lever. As for this principle of leverage, the point of application of lever is set closer to the fulcrum compared to the point of effort of lever, by which the light source unit 60 can be pushed into the attachment direction with a smaller force, and the cover 54 can be attached to the light source replacement opening 53c easily.

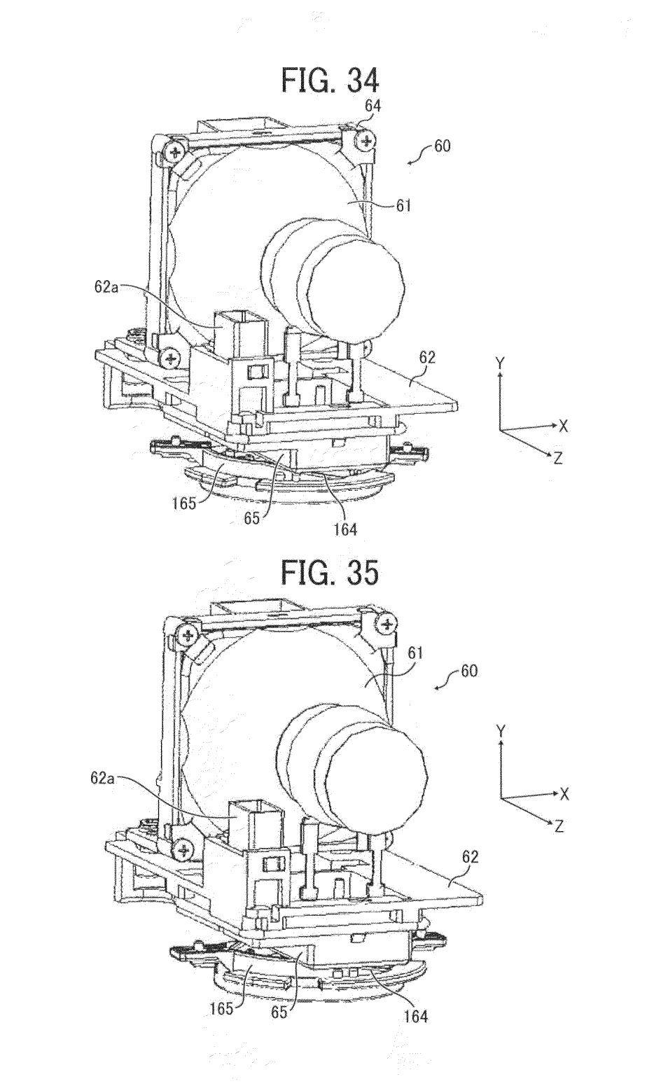

Further, as shown in FIGS. 32B and 34, when the rotate-able member 54a is at the unlock position, the slope 164 faces the pass-through area 65 of the light source bracket 62, but the light source unit 60 is not yet pushed by the push member 165. When the rotate-able member 54a is rotated from the unlock position to the lock position, the push member 165 formed with the slope 164 contacts the duct 65 or pass-through area 65 provided for the light-source bracket 62, in which the duct 65 can be used as a pushed member, which may be also referred to the abutted member. Specifically, at least a portion of faces of the duct 65 can be used as the abutted member.

When the rotate-able member 54a is further rotated to the lock position, the push member 165 formed with the slope 164 can further push the duct 65. With this configuration, the power source side connector 171 of male type can be inserted into the connector 62a of female type completely, by which the power source side connector 171 and the connector 62a can be connected securely. Further, an end of the connector 62a contacts a contact portion T3 of the power source side connector 171. When the rotate-able member 54a is rotated to the lock position shown in FIGS. 32C and 35, the push member 165 can push the duct 65, by which the connector 62a of the light source unit 60 is sandwiched and fixed by the push member 165 and the contact portion T3 of the power source side connector 171.

As above described, when the cover 54 is locked to the base member 53 of the projector 1, the light source unit 60 is pushed by the pushing protrusion 152 and the push member 165 of the cover 54, by which the light source unit 60 can be sandwiched and fixed in the projector 1. With this configuration, the light source unit 60 can be fixed at a given position in the Y direction in the projector 1. Further, the cover 54 can be more likely deformed elastically compared to the contact member disposed in the lighting unit bracket 26 and a power source side connector 171 when the light source unit 60 is attached in the projector 1. Therefore, when the cover 54 is locked to the base member 53 of the projector 1, the pushing protrusion 152 and the push member 165 can push the light source unit 60, and the cover 54 deforms elastically. With this configuration, the fixing position of the light source unit 60 in the projector 1 may not be deviated in the Y direction.

Further, by providing the slope 164 that gradually increases its height toward the push member 165, an operation resistance occurring when the rotate-able member 54a is rotated from the unlock position to the lock position can become a constant level. With this configuration, a greater force is not required when rotating the rotate-able member 54a to the lock position. Further, the two push members 165 can contact at two points of the duct 65, wherein the two points are far with each other.

Further, because the push member 165 formed with the slope 164 can be disposed for a plurality numbers in a rotation direction of the rotate-able member 54a with a given pitch such as an equal pitch, when the rotate-able member 54a is rotated to the lock position to push the light source unit 60 with a pushing force, a reaction force of the pushing force can be received equally on the rotate-able member 54a. Therefore, when the rotate-able member 54a is rotated to the lock position, the inclination of the rotate-able member 54a can be prevented, and thereby the friction of the flange 162 of the rotate-able member 54a and the claw 153a can be reduced. With this configuration, an increase of operation resistance when moving the rotate-able member 54a to the lock position can be reduced.

Further, when removing the cover 54 from the base member 53, the rotate-able member 54a is rotated into the unlocking direction which is opposite the above described locking direction. When the rotate-able member 54a is rotated in the unlocking direction, the lock member 161 is displaced from the notch 53d, and the cover 54 is unlocked from the base member 53. When the rotate-able member 54a is further rotated from the lock condition, the lock member 161 contacts the contact member 156, and the rotation of the rotate-able member 54a is stopped. With this configuration, a user operating the rotate-able member 54a can be informed that the cover 54 is unlocked from the base member 53.

In the above described example embodiment, the cover 54 can be locked and unlocked by operating the rotate-able member 54a, by which the replacement of the light source unit 60 can be conducted without using a specific tool such as a screwdriver. With this configuration, the replacement of the light source unit 60 can be conducted easily. In conventional configurations, a cover such as the cover 54 may be fixed using a screw, and thereby the screwdriver is required when the light source unit 60 is replaced.

Further, when the locking operation of the cover 54 to the base member 53 of the projector 1 is conducted, the light source unit 60 can be positioned and fixed in the Y direction correctly, which is an attachment/detachment direction of the light source unit 60, by which the light source unit 60 can be replaced with a simple operation. Further, because the light source unit 60 can be positioned and fixed in the Z direction and the X direction correctly by installing the light source unit 60 in the projector 1, the light source unit 60 can be replaced with a simple operation.

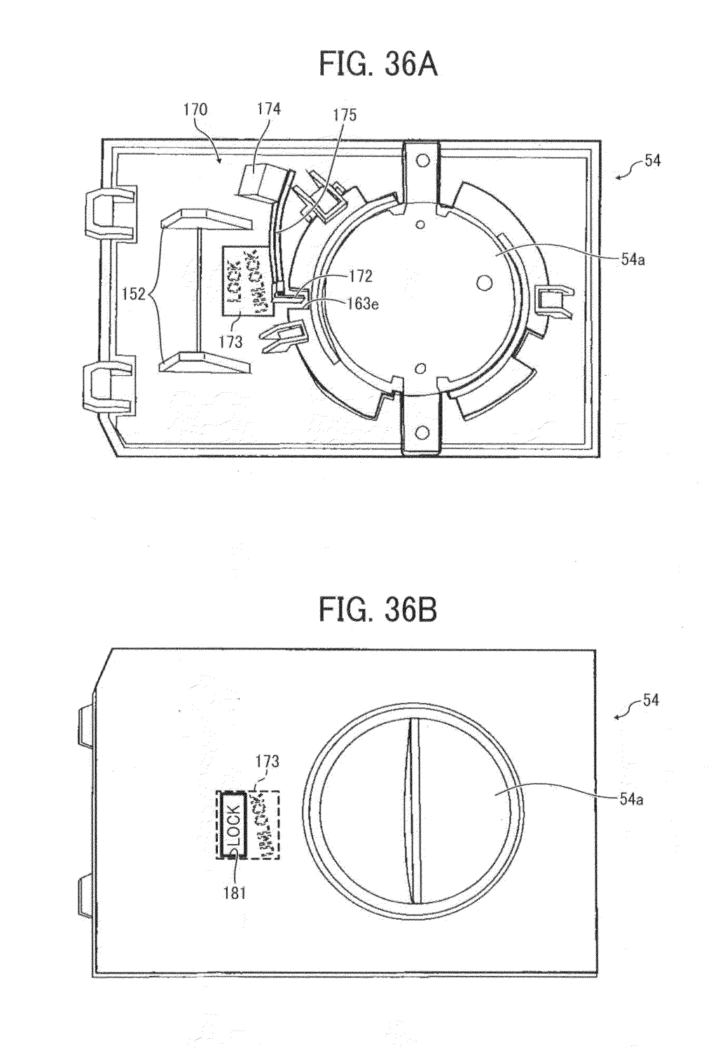

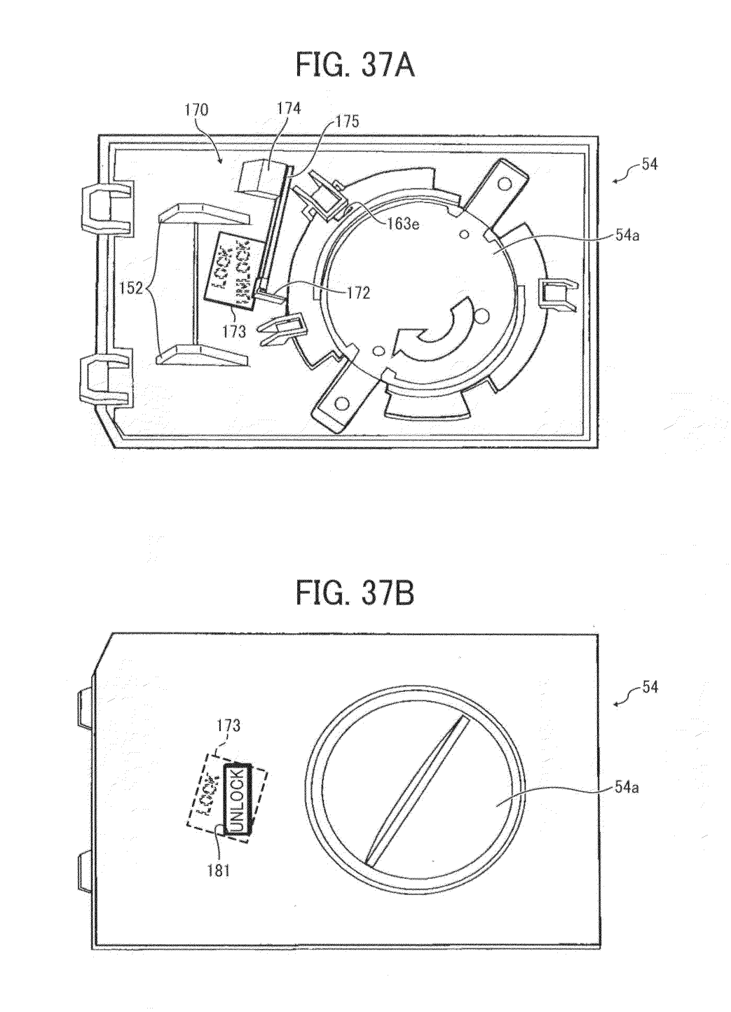

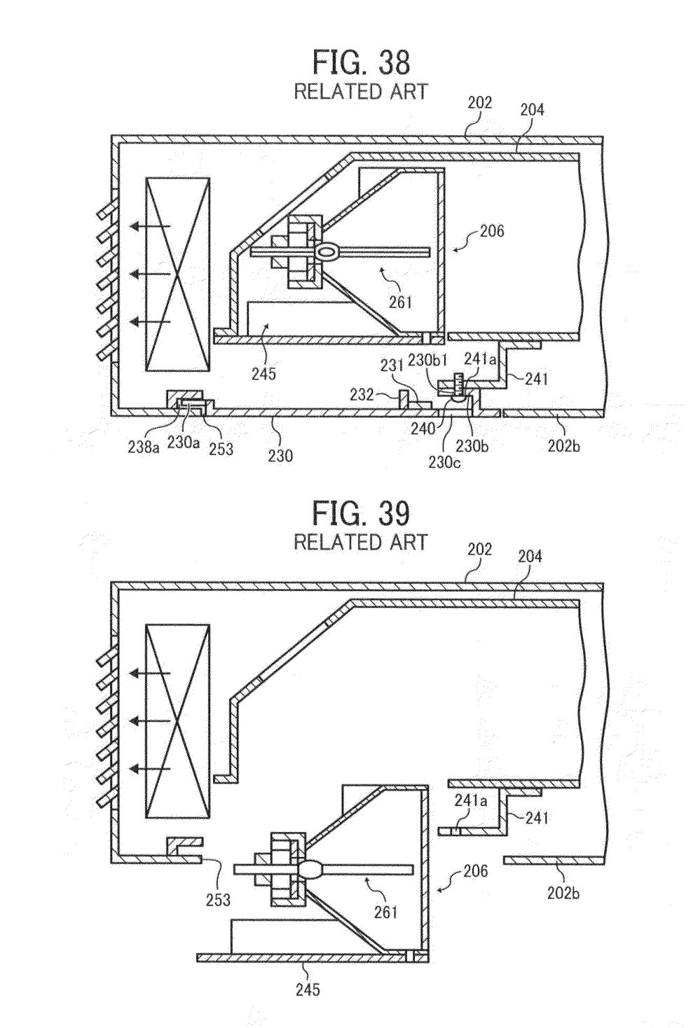

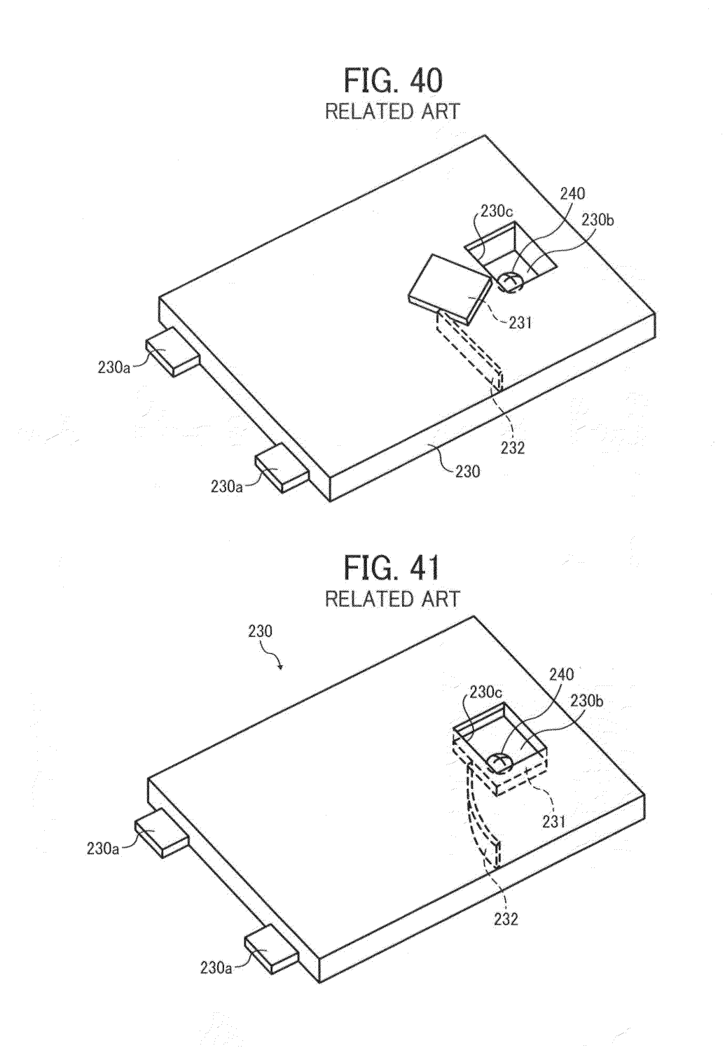

Because the light source 61 employs, for example, a halogen lamp, a metal-halide lamp, or a high-pressure mercury vapor lamp, the light source 61 becomes hot when the light source 61 emits light. The light source bracket 62 and the knob 66 become hot due to the heat conduction and radiant heat from the light source 61. When the light source 61 ends its lifetime, the light source unit 60 is replaced with a new one, in which the cover 54 and the light source bracket 62 are picked by a finger. Therefore, if the cover 54 and the knob 66 are at a high temperature condition, a user feels uncomfortable hot condition when conducting the replacement work of the light source unit 60. In view of the hot condition of the cover 54, a regulating mechanism 170 is provided to regulate a rotational sliding movement of the rotate-able member 54a of the cover 54, in which the cover 54 is not released from the locked condition if the temperature of the light source bracket 62 and/or the knob 66 is high. A description is given of the regulating mechanism 170 with reference to FIGS. 36 and 37.

FIG. 36 shows a condition that the rotational sliding movement of the rotate-able member 54a is regulated by the regulating mechanism 170, and FIG. 37 shows a condition that the rotational sliding movement of the rotate-able member 54a is not regulated by the regulating mechanism 170. FIGS. 36A and 37A show a rear or inner face of the cover 54 that faces the light source unit 60, and FIGS. 36B and 37B show a front or outer face of the cover 54a.

As shown in FIGS. 36A and 37A, the regulating mechanism 170 can be configured as the regulating device 170 including a heat-sensitive member 175 made of, for example, a bimetal plate, and a regulating plate 172 used as a regulator. Further, the regulating device 170 includes a display plate 173, in which the display plate 173 is attached at one end of the heat-sensitive member 175, and other end of the heat-sensitive member 175 is attached to a heat-sensitive member attachment 174 projected from a rear face of the cover 54. The display plate 173 includes, for example, characters of LOCK and UNLOCK.

The rotate-able member 54a is provided with a regulation cutout 163e. When the rotate-able member 54a is at the lock position that locks the cover 54, the regulation cutout 163e faces the regulating plate 172. Further, as shown in FIGS. 36B and 37B, the cover 54 is disposed with a display window 181, which is an opening, through which the characters of LOCK or UNLOCK on the display plate 173 can be displayed.

As shown in FIG. 36A, when the heated light source 61 heats the heat-sensitive member 175, the heat-sensitive member 175 is deformed such as curved, by which the front edge of the heat-sensitive member 175 moves toward the rotate-able member 54a. Then, the regulating plate 172 disposed at the front edge of the heat-sensitive member 175 is inserted into the regulation cutout 163e of the rotate-able member 54a. If the rotate-able member 54a is rotated under the inserted condition, the regulation cutout 163e contacts the regulating plate 172, by which the rotation movement of the rotate-able member 54a can be regulated or limited, and an opening of the cover 54 when the temperature of the light source bracket 62 and/or the knob 66 is high can be prevented.

Further, when the front edge of the heat-sensitive member 175 moves to the rotate-able member 54a to insert the regulating plate 172 into the regulation cutout 163e as above described, the display plate 173 disposed at the front edge of the heat-sensitive member 175 moves toward the rotate-able member 54a, and the character of LOCK can be displayed through the display window 181 as shown in FIG. 36B. With this configuration, a user can be informed that the rotation movement of the rotate-able member 54a is regulated or limited.

When the light source 61 is stopped and set light-OFF, the temperature of the heat-sensitive member 175 decreases, and then the curving of the heat-sensitive member 175 is gradually released and the heat-sensitive member 175 becomes a straight shape as shown in FIG. 37A. When the heat-sensitive member 175 becomes the straight shape, the regulating plate 172 disposed at the front edge of the heat-sensitive member 175 exits from the regulation cutout 163e of the rotate-able member 54a, by which a rotation movement of the rotate-able member 54a is not regulated, which means the rotation movement regulation is released. With this configuration, the rotate-able member 54a can be rotated, the cover 54 can be removed, and the replacement of the light source unit 60 can be conducted when the temperature of the light source bracket 62 and the knob 66 is decreased.

Further, when the front edge of the heat-sensitive member 175 becomes a straight shape, the display plate 173 disposed at the front edge of the heat-sensitive member 175 moves away from the rotate-able member 54a, and the character of UNLOCK can be displayed through the display window 181 as shown in FIG. 37B. With this configuration, a user can be informed that the rotation movement of the rotate-able member 54a is not regulated.

In the above described image projection apparatus such as the projector 1, the projector 1 includes the light source unit 60, including the light source 61, detachably attached to a body of the image projection apparatus, an image generation unit to generate an image using light emitted from the light source; the projection optical units A and B to project the image; and an cover 54 to open or close an opening 155 disposed for attachment and detachment of the light source unit with respect to the body of the image projection apparatus, the openably closable 54 cover includes an operation device such as rotate-able member 54a, and a regulating device 170. The operation device 54a is moveably attached to the cover 54. The operation device 54a is selectively operable in a first mode, in which the openably closable cover is locked to the body of the image projection apparatus, and a second mode, in which the openably closable cover is unlocked from the body of the image projection apparatus. The regulating device 170 regulates movement of the operation device 54a when the temperature of the light source unit 60 becomes a given level or more. With this configuration, as above described, a touching of user to the hot-heated light source unit 60 can be prevented, and the replacement work of the light source 61 can be conducted easily

In the above described image projection apparatus such as the projector 1, a display device such as the display plate 173 and the display window 181 can be provided. The display device displays whether movement of the operation device such as the rotate-able member 54a is regulated or not by the regulating device 170. With this configuration, as above described, a user can be informed whether the rotate-able member 54a is regulated or not, and the rotate-able member 54a under the operation-regulated mode is not operated forcibly, by which damages to the projector 1 can be reduced, in particular prevented.

In the above described image projection apparatus such as the projector 1, the regulating device 170 includes the heat-sensitive member 175, in which one end portion of the heat-sensitive member 175 is fixed to the cover 54 and other end portion of the heat-sensitive member 175 is attached with the regulator such as the regulating plate 172 to regulate movement of the operation device such as the rotate-able member 54a. The heat-sensitive member 175 can change its shape when temperature changes. Specifically, when the temperature of the light source unit 60 becomes a given level or more, the heat-sensitive member 175 changes its shape so that the regulator is set to the regulation position that regulates the movement of the operation device, and when the temperature of the light source unit 60 becomes less than the given level, the heat-sensitive member 175 changes its shape so that the regulator is set to the retracted position released from the regulation position. With this configuration, as above described, when the temperature of the light source unit 60 becomes the given level or more, the movement of the operation device can be regulated.

In the above described image projection apparatus such as the projector 1, the operation device such as the rotate-able member 54a has the regulation cutout 163e that faces the regulator such as the regulating plate 172 when the operation device is at the first mode. When the temperature of the light source unit 60 becomes the given level or more, the regulator inserts into the regulation cutout 163e to regulate the movement of the operation device. With this configuration, as above described, when the temperature of the light source unit 60 becomes the given level or more, the movement of the operation device can be regulated.

In the above described image projection apparatus such as the projector 1, the light source unit 60 is provided with the abutted member that can be pushed by the push member provided for the cover 54 such as the push member 165 and the pushing protrusion 152 when the light source unit 60 is attached into the projector 1. The abutted member may be the duct 65 shown in FIG. 32. A pushing operation of the pushing member can be concurrently conducted with a fixing operation of the cover 54 to the body of the projector 1. With this configuration, as above described, the light source unit 60 can be fixed in the projector 1 when the cover 54 is locked to the projector 1. Conventional projectors may conduct a fixing operation of a light source unit in the projectors separately from the locking operation of the openably closable cover to the projectors. Compared to conventional projectors, the replacement work of the light source unit 60 can be conducted easily in the above described example embodiment.

In the above described example embodiment, the operation device provided for the openably closable cover is operated to conduct the locking and unlocking of the openably closable cover with respect to the projector. Therefore, compared to conventional projectors that the openably closable cover is fixed to the projectors using a screw, a tool such as a screwdriver is not required when locking and unlocking the openably closable cover with respect to the projector. With this configuration, the replacement work of the light source unit can be conducted easily, and thereby the replacement work of the light source can be conducted easily.

Further, when the temperature of the light source unit becomes a given level or more, the regulating device regulates the movement of the operation device, in which the operation of the operation device when the light source unit is at high temperature can be prevented and unlocking of the openably closable cover at high temperature can be prevented. With this configuration, a user touching of the light source unit at high temperature can be prevented.

Numerous additional modifications and variations are possible in light of the above teachings. It is therefore to be understood that within the scope of the appended claims, the disclosure of the present invention may be practiced otherwise than as specifically described herein. For example, elements and/or features of different examples and illustrative embodiments may be combined each other and/or substituted for each other within the scope of this disclosure and appended claims.

What is claimed is:

1. An image projection apparatus comprising:
a detachable light source unit, including a light source, attached to a body of the image projection apparatus;
an image generation unit to generate an image using light emitted from the light source;
a projection optical unit to project the image; and
an openably closable cover to open or close an opening disposed for attachment and detachment of the light source unit with respect to the body of the image projection apparatus, the openably closable cover including:
a moveable operation device attached to the openably closable cover, selectively operable in a first mode, in which the openably closable cover is locked to the body of the image projection apparatus, and a second mode, in which the openably closable cover is unlocked from the body of the image projection apparatus; and
a regulating device to regulate movement of the operation device when the temperature of the light source unit becomes a given level or more.

2. The image projection apparatus of claim 1, further comprising a display device to display information indicating whether movement of the operation device is regulated or not by the regulating device.

3. The image projection apparatus of claim 1, wherein the regulating device includes a heat-sensitive member that changes its shape depending on temperature,
wherein the heat-sensitive member has one end fixed to the openably closable cover and other end attached with a regulator used for regulating movement of the operation device,
wherein when the temperature of the light source unit becomes a given level or more, the heat-sensitive member changes its shape so that the regulator is set at a regulation position that regulates the movement of the operation device,
wherein when the temperature of the light source unit becomes less than the given level, the heat-sensitive member changes its shape so that the regulator is set at a retracted position, at which the regulator is released from the regulation position.

4. The image projection apparatus of claim 3, wherein the operation device includes a regulation cutout facing the regulator when the operation device is in the first mode,
wherein when the temperature of the light source unit becomes the given level or more, the regulator inserts into the regulation cutout to regulate the movement of the operation device.

5. The image projection apparatus of claim 1, further comprising:
an abutted member provided for the light source unit; and
a pushing member that pushes the abutted member provided for the light source unit when the light source unit is attached to the body of the image projection apparatus,
wherein a pushing operation by the pushing member is concurrently conductable with a fixing operation of the openably closable cover to the body of the image projection apparatus.
